(19) United States
(12) Patent Application Publication
(10) Pub. No.: US 2022/0248759 A1
(43) Pub. Date: Aug. 11, 2022

(54) Generating Aerosol Using Vibration and Heating in a Vaporizer Device

(71) Applicant: Loto Labs, Inc., Belmont, CA (US)

(72) Inventor: Andrew L. Bleloch, Kenmore, WA (US)

(21) Appl. No.: 17/612,898

(22) PCT Filed: May 21, 2020
(86) PCT No.: PCT/US2020/034023

§ 371 Date: Nov. 19, 2021

Related U.S. Application Data
(60) Provisional application No. 62/850,736, filed on May 21, 2019.
(60) Provisional application No. 62/877,423, filed on Jul. 23, 2019.

(51) Int. Cl. A24F 40/46; H05B 6/10; A24F 40/50; A24F 40/465; A24F 40/485; A24F 40/42; A24F 40/30; A24F 40/10

(52) U.S. Cl. CPC A24F 40/46; H05B 6/108; A24F 40/50; A24F 40/465; H05B 2203/021; A24F 40/42; A24F 40/30; A24F 40/10; A24F 40/485

(57) ABSTRACT

Provided are devices for aerosolization of an aerosolizable substance. For example, a device may include a heating element, a wick element, and a transducer element. The heating element may be configured to heat the wick element via conduction. The heating element may be attached to the transducer element. The transducer element may be configured to cause the heating element to vibrate. Additionally or alternatively, a device may include a heating element, a wick element, and a magnetic element. Additionally or alternatively, a device may include a heating coil and a susceptor element. Additionally or alternatively, a device may include a heating element, a reservoir with an opening, a cover assembly positioned over the opening, and a transducer element configured to vibrate the cover assembly. Additionally or alternatively, a device may include a heating coil, a susceptor element, a reservoir with an opening, and a cover assembly positioned over the opening.

### CROSS-REFERENCE TO RELATED APPLICATIONS

This application claims priority to U.S. Provisional Application No. 62/850,736, filed May 21, 2019, and U.S. Provisional Application No. 62/877,423, filed Jul. 23, 2019, the contents of which are hereby incorporated by reference in their entireties.

### BACKGROUND

### 1. Field

This disclosure relates generally to components of a vaporizer device and, in some non-limiting embodiments, to generating an aerosol using vibration and heating in a vaporizer device.

### 2. Technical Considerations

A vaporizer may include an electronic device that simulates tobacco smoking. In some instances, a vaporizer may include a handheld battery-powered vaporizer that produces an aerosol (e.g., a vapor) instead of smoke produced by burning tobacco. A vaporizer may include a heating element that is used to aerosolize (e.g., atomize) an aerosolizable substance (e.g., a substance that produces an aerosol when heating, such as a liquid, a liquid solution, a wax, an herbal material, etc.) to produce the aerosol. In some examples, the liquid solution may be referred to as an e-liquid. The aerosol produced by the vaporizer may include particulate matter. In some instances, the particulate matter may include propylene glycol, glycerin, nicotine, and/or flavoring.

### BRIEF DESCRIPTION OF THE DRAWINGS

Additional advantages and details of the disclosure are explained in greater detail below with reference to the exemplary embodiments that are illustrated in the accompanying schematic figures, in which:

FIG. 1 is a diagram of a non-limiting embodiment of a vaporizer device;

FIG. 2 is a diagram of a non-limiting embodiment of an implementation of the vaporizer device shown in FIG. 1;

FIGS. 3A and 3B are schematic diagrams of components of non-limiting embodiments of an implementation of the vaporizer device shown in FIGS. 1 and 2;

FIGS. 4A and 4B are diagrams of a non-limiting embodiment of an implementation of an implementation of the vaporizer device shown in FIG. 1;

FIGS. 5A and 5B are diagrams of a non-limiting embodiment of an implementation of the vaporizer device shown in FIG. 1;

FIG. 6 is a diagram of a non-limiting embodiment of an implementation of the vaporizer device shown in FIG. 1;

FIG. 7A is a diagram of a non-limiting embodiment of an implementation of the vaporizer device shown in FIG. 1;

FIG. 7B is a diagram of a non-limiting embodiment of an implementation of the vaporizer device shown in FIG. 1;

FIG. 8A is a diagram of a non-limiting embodiment of an implementation of the vaporizer device shown in FIG. 1;

FIG. 8B is a diagram of a non-limiting embodiment of an implementation of the vaporizer device shown in FIG. 1;

FIG. 9A is a diagram of a non-limiting embodiment of an implementation of the vaporizer device shown in FIG. 1;

FIG. 9B is a diagram of a non-limiting embodiment of an implementation of the vaporizer device shown in FIG. 1; and

FIG. 10 is a diagram of a non-limiting embodiment of components of a vaporizer device.

### DETAILED DESCRIPTION

The present disclosure relates generally to systems, methods, and products used for generating an aerosol using vibration and heating in a vaporizer device. Accordingly, various embodiments are disclosed herein of devices, systems, computer program products, apparatus, and/or methods for generating an aerosol using vibration and heating in a vaporizer device.

Non-limiting embodiments are set forth in the following numbered clauses:

Clause 1: A device for aerosolization of an aerosolizable substance comprising: a resistive heating element; a wick element; and a transducer element; and wherein the resistive heating element is configured to heat the wick element via conduction; and wherein the resistive heating element is attached to the transducer element; and wherein the transducer element is configured to cause the heating element to vibrate.

Clause 2: The device of clause 1, further comprising: at least one processor programmed or configured to: control the transducer element to cause the resistive heating element to vibrate.

Clause 3: The device of clauses 1 or 2, further comprising: a support, wherein the transducer element is attached to the support.

Clause 4: The device of any of clauses 1-3, further comprising: a housing; a frame located within the housing; and wherein the support is attached to the frame; wherein the support is configured to hold the transducer element and the resistive heating element in a predetermined position within the housing to allow the heating element to heat the wick element.

Clause 5: The device of any of clauses 1-4, wherein the resistive heating element comprises a resistive heating coil.

Clause 6: The device of any of clauses 1-5, wherein the resistive heating element is in contact with the wick element and wherein the wick element is positioned within the resistive heating element.

Clause 7: A device for aerosolization of an aerosolizable substance comprising: a resistive heating element; a wick element; and a magnetic element; and wherein the resistive heating element is configured to heat the wick element via conduction; and wherein the magnetic element is configured to cause the resistive heating element to vibrate.

Clause 8: The device of clause 7, wherein the magnetic element comprises a ferromagnetic material.

Clause 9: A device for aerosolization of an aerosolizable substance comprising: a induction heating element; and a susceptor element; and wherein the induction heating element is configured to cause the susceptor element to generate heat based on induction; and wherein the induction heating element is configured to cause the susceptor element to vibrate based on an alternating current magnetic field generated by the induction heating element.

Clause 10: The device of clause 9, further comprising: at least one processor programmed or configured to: control the induction heating element to cause the susceptor element to vibrate.

Clause 11: The device of clauses 9 or 10, wherein the susceptor element is coupled to a membrane diaphragm, wherein the membrane diaphragm is configured to allow the susceptor element to vibrate when the susceptor element receives the alternating current magnetic field generated by the induction heating element.

Clause 12: The device of any of clauses 9-11 wherein the membrane diaphragm is attached to an opening of a reservoir, and wherein the membrane diaphragm is configured to hold a first portion of the susceptor element within the induction heating element and a second portion of the susceptor element within the reservoir.

Clause 13: The device of any of clauses 9-12, wherein the susceptor element comprises a central portion and a plurality of conductive filaments attached to the central portion.

Clause 14: The device of any of clauses 9-13, wherein the membrane diaphragm comprises a first portion and a second portion attached to the first portion, wherein the first portion is coupled to the susceptor element and wherein the second portion is attached to an opening of a reservoir.

Clause 15: The device of any of clauses 9-14, wherein the susceptor element comprises a central portion having a conical shape, wherein the central portion is constructed from a foil perforated with a plurality of apertures.

Clause 16: The device of any of clauses 9-15, wherein a membrane diaphragm is attached to an opening of a reservoir, and wherein the membrane diaphragm is configured to hold at least a portion of the susceptor element within the induction heating element.

Clause 17: A device for aerosolization of an aerosolizable substance comprising: a resistive heating element; a reservoir configured to contain an aerosolizable substance, the reservoir comprising an opening; a cover assembly positioned over the opening of the reservoir; a transducer element configured to vibrate the cover assembly; and wherein the resistive heating element is configured to heat the aerosolizable substance via induction; and wherein the resistive heating element is positioned adjacent the opening of the reservoir.

Clause 18: The device of clause 17, further comprising: at least one processor programmed or configured to: control the resistive heating element to cause the resistive heating element to heat the aerosolizable substance via conduction, and control the transducer element to cause the transducer element to vibrate.

Clause 19: The device of clauses 17 or 18, further comprising: a support, wherein the transducer element is attached to the support.

Clause 20: The device of any of clauses 17-19, wherein the cover assembly is attached to the transducer element.

Clause 21: The device of any of clauses 17-20, wherein the cover assembly is constructed from a foil perforated with a plurality of apertures.

Clause 22: The device of any of clauses 17-21, further comprising: a seal adjacent the opening of the reservoir, wherein the seal is positioned between a rim of the reservoir and the cover assembly.

Clause 23: A device for aerosolization of an aerosolizable substance comprising: an induction heating element; a susceptor element; a reservoir configured to contain an aerosolizable substance, the reservoir comprising an opening; a cover assembly positioned over the opening of the reservoir; and wherein the induction heating element is configured to cause the susceptor element to generate heat based on induction; and wherein the induction heating element is positioned adjacent the opening of the reservoir.

Clause 24: The device of clause 23, further comprising: at least one processor programmed or configured to: control the induction heating element to cause the susceptor element to generate heat based on induction.

Clause 25: The device of clauses 23 or 24, wherein the cover assembly is constructed from a foil perforated with a plurality of apertures.

Clause 26: The device of any of clauses 23-25, wherein the induction heating element is configured to cause the cover assembly to vibrate based on an alternating current magnetic field generated by the induction heating element.

Clause 27: The device of any of clauses 23-26, further comprising: a seal adjacent the opening of the reservoir, wherein the seal is positioned between a rim of the reservoir and the cover assembly.

Clause 28: The device of any of clauses 23-27, further comprising: a magnetic element, wherein the magnetic element is attached to the cover assembly and is configured to cause the cover assembly to vibrate based on an alternating current magnetic field generated by the induction heating element.

Clause 29: The device of any of clauses 23-28, further comprising: a transducer element, wherein the transducer element is attached to the cover assembly and is configured to vibrate the cover assembly.

Clause 30: The device of any of clauses 23-29, wherein the susceptor element is a first susceptor element, wherein the reservoir is a first reservoir configured to contain a first aerosolizable substance, and the device further comprising: a second reservoir configured to contain a second aerosolizable substance, wherein the first aerosolizable substance is different than the second aerosolizable substance; a second susceptor element; wherein the first susceptor element is positioned within an opening of the second reservoir; and wherein the second susceptor element is positioned within an opening of the second reservoir.

Clause 31: The device of any of clauses 23-30, wherein the reservoir is a first reservoir configured to contain a first aerosolizable substance, further comprising: a second reservoir comprising an opening, wherein the second reservoir is configured to contain a second aerosolizable substance, wherein the susceptor element is positioned within the second reservoir, and wherein the second reservoir is positioned within the induction heating element; wherein the opening of the second reservoir is adjacent to the opening of the first reservoir.

Clause 32: The device of any of clauses 23-31, wherein the opening of the second reservoir is aligned with the opening of the first reservoir.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” and “based at least in part on” unless explicitly stated otherwise.

Non-limiting embodiments of the disclosed subject matter are directed to devices, methods, and computer program products for generating an aerosol using vibration including, but not limited to, generating an aerosol using a combination of vibration and heating. For example, non-limiting embodiments of the disclosed subject matter provide a device including a resistive heating element, a wick element, and a transducer element so that the resistive heating element may heat the wick element via conduction and the transducer element may cause the heating element to vibrate.

Additionally or alternatively, a device may include a heating element, a wick element, and a magnetic element. Additionally or alternatively, a device may include a heating coil and a susceptor element. Additionally or alternatively, a device may include a heating element, a reservoir with an opening, a cover assembly positioned over the opening, and a transducer element configured to vibrate the cover assembly. Additionally or alternatively, a device may include a heating coil, a susceptor element, a reservoir with an opening, and a cover assembly positioned over the opening. Such embodiments provide techniques and devices that provide improved generating of the aerosol using a combination of vibration and heating compared to heating alone. For example, certain vaping devices may use heat (e.g., with wicking and/or airflow) to create an aerosol from a vaporizable substance (e.g., a liquid, semi-solid, waxy, and/or solid substance), that may be inhaled.

However, such heat-based vaping devices may burn the vaporizable substance, resulting in a deteriorated user experience and/or health risks. In contrast, the disclosed subject matter may be used to combine vibration and heating to reduce (e.g., eliminate, decrease, and/or the like) burning (e.g., to achieve heat-not-burn aerosolization) such that the aerosolizable substance may be heated to volatilize components thereof and then vibrations may be used to create an aerosol that may be inhaled.

As such, the techniques and devices described herein may improve vaping by lowering the temperature (e.g., the temperature to which a heating element would need to heat an aerosolizalbe substance) required to produce a satisfying aerosol. Additionally or alternatively, the techniques and devices described herein provide aerosolizing a first substance (e.g., solid) at a warmer temperature simultaneously with aerosolizing a second substance (e.g., liquid) at a cooler temperature so that the aerosol from the second substance may combine with the aerosol of the first substance to cool and/or flavor the resultant combined aerosol.

Additionally or alternatively, the techniques and devices described herein provide generation of an aerosol using vibration to disrupt the surface of the aerosolizable substance to thereby cause at least one substance component to form aerosol droplets (and/or enhance the forming of such aerosol droplets caused by heating alone), e.g., at a temperature below the boiling point of such substance components, so that such aerosol droplets may be carried in the airflow, thus resulting in an increase in the amount of aerosol produced at a given temperature and/or reduce the temperature at which aerosolization is possible. Such reduction in the temperature required to create the desired aerosol is advantageous at least because it may reduce the presence of undesirable thermal degradation trace chemicals, some of which are known to be toxic or carcinogenic.

Additionally or alternatively, the techniques and devices described herein provide a lower temperature that can be used to produce a vapor (e.g., an aerosol) that is satisfying to the user while reducing the quantity of undesirable thermal degradation products that are inhaled. Additionally or alternatively, the techniques and devices described herein provide simultaneous production of two aerosols, thereby allowing the second aerosol to cool an otherwise uncomfortably hot first aerosol (e.g., with a water aerosol, such as mist and/or the like). Additionally or alternatively, the techniques and devices described herein provide simultaneously vaping two aerosolizable substances that have different vaping temperatures (e.g., nicotine vaping combined with cannabidiol wax vaping and/or the like). Additionally or alternatively, the techniques and devices described herein provide generation of an aerosol using approximately the same power (e.g., from a battery) as heating alone, thereby enabling implementation in a compact, hand-held device. Additionally or alternatively, the techniques and devices described herein provide enhanced atomization (e.g., from the combination of vibration and heating) relative to evaporation alone (e.g., heating alone), thus enhancing the production of an aerosol at lower temperatures. For example, a surface wetted by the vaping liquid (e.g., a surface of a wick element) may be moved rapidly (e.g., vibrated) to shake off droplets which may be carried in the airflow, and such vibration may be combined with some heating of the aerosolizable substance (e.g., prior to moving/vibrating the surface) to reduce the viscosity of the substance.

Additionally or alternatively, the techniques and devices described herein provide producing an aerosol without the need for one or more components of the substance to be above its boiling point, thereby avoiding any thermal degradation products that involve reactions from boiling a component of a substance (e.g., propylene glycol). Additionally or alternatively, the techniques and devices described herein provide combining a heat source to reduce the viscosity of the liquid to be aerosolized with vibration to produce a new way of creating an aerosol of substances (e.g., substances containing e-liquid, such as nicotine; herbal extracts that may be dissolved in an oil or solvent; waxes or wax-like herbal extracts; and/or the like). Additionally or alternatively, the techniques and devices described herein provide use of a vibrating mesh in conjunction with heating, such that the temperature at which a satisfying aerosol is created may be reduced, thus producing fewer undesirable thermal degradation products (e.g., undesirable HPHP substances such as acetaldehyde, acrolein, and/or formaldehyde).

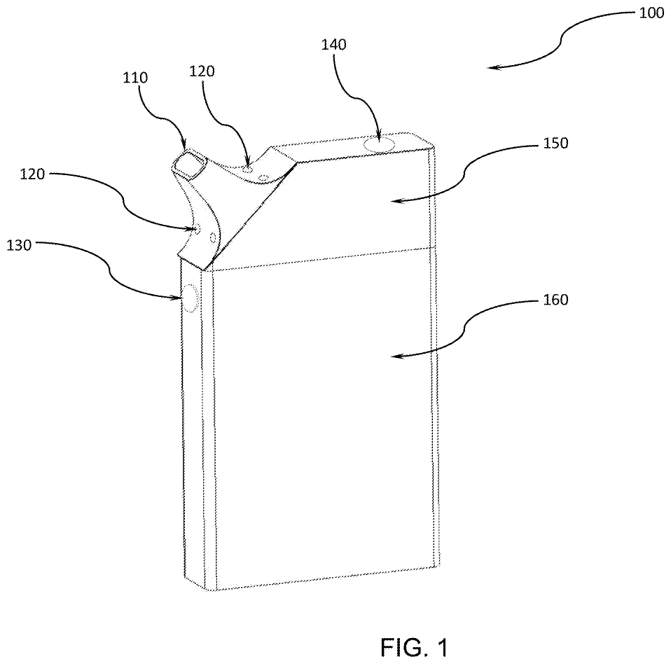

FIG. 1 is a diagram of a non-limiting embodiment of vaporizer device 100. As shown in FIG. 1, vaporizer device 100 includes first housing portion 150 and second housing portion 150. As shown in FIG. 1, first housing portion 150 and second housing portion 160 of vaporizer device 100 may be coupled together via an interference fit. In some non-limiting embodiments, first housing portion 150 may be a part of vaporizer device 100 that contains a reservoir of an aerosolizable substance and may include components of vaporizer device 100 that are used to generate an aerosol from the aerosolizable substance. In some non-limiting embodiments, second housing portion 160 may be a part of vaporizer device 100 that contains electrical components of vaporizer device 100 that control the components of vaporizer device 100 to generate the aerosol from the aerosolizable substance. In some non-limiting embodiments, the components contained in first housing portion 150 may be electrically connected to the electrical components in second housing portion 160. For example, the components contained in first housing portion 150 may be electrically connected to the electrical components in second housing portion 160 by wires and/or conducting traces. In some non-limiting embodiments, one or more electrical components of vaporizer device 100 may be contained in first housing portion 150 or second housing portion 160. For example, second housing portion 160 may include an induction heating element (e.g., an induction heating coil) that is used to generate the aerosol from the aerosolizable substance and first housing portion 150 may include the reservoir that contains the aerosolizable substance. In this way, first housing portion 150 may be replaceable such that when the aerosolizable substance in the reservoir is depleted, another first housing portion 150 may be coupled to second housing portion 160 and vaporizer device 100 may be used to generate the aerosol from the aerosolizable substance in the reservoir of first housing portion 150 that was replaced. Furthermore, this may allow a user to save on the expense of replacing second housing portion 160 when the aerosolizable substance in the reservoir of first housing portion 150 is depleted.

As further shown in FIG. 1, vaporizer device 100 may include stopper 140. In some non-limiting embodiments, stopper 140 may be placed at (e.g., positioned within, screwed into position, etc.) a port that is used for filling a reservoir of vaporizer device 100 with an aerosolizable substance (e.g., a liquid aerosolizable substance). When stopper 140 is placed at the port, stopper 140 may prevent the aerosolizable substance in the reservoir from leaking out of the reservoir. When stopper 140 is removed from the port, the reservoir may be refilled via the port. In some non-limiting embodiments, vaporizer device 100 may not include stopper 140. For example, if first housing portion 150 is designed to be replaceable, vaporizer device 100 may omit stopper 140.

As further shown in FIG. 1, vaporizer device 100 may include button 130. In some non-limiting embodiments, button 130 may be used by a user to interface with vaporizer device 100. Vaporizer device 100 can be configured to perform actions based on a signal produced by button 130 when a user applies pressure to button 130. In some non-limiting embodiments, button 130 provides a signal to the electrical components (e.g., control electronics, such as a control device) contained in second housing portion 160. The electrical components can be designed (e.g., configured, programmed, etc.) to respond to a signal produced when button 130 is engaged. In one example, a first duration of pressure applied to button 130 may cause vaporizer device 100 to activate (e.g., to turn on). In another example, a second duration of pressure applied (e.g., a duration of pressure that is shorter than the first duration of pressure) to button 130 may cause a heating and vibration cycle to generate an aerosol. In some non-limiting embodiments, a plurality of consecutive durations of pressure applied to button 130 may cause a Bluetooth pairing process to be performed. In some non-limiting embodiments, vaporizer device 100 may not include button 130. In some non-limiting embodiments, vaporizer device 100 may omit button 130 and may initiate a heating and vibration cycle based on a signal from a sensor (e.g., a pressure sensor, an accelerometer, etc.) included in vaporizer device 100. For example, the sensor may sense suction and/or the sensor may sense motion of vaporizer device 100 to initiate the heating and vibration cycle. In some non-limiting embodiments, the Bluetooth pairing process may be performed based on a signal from an accelerometer when vaporizer device 100 is moved (e.g., shaken and/or rotated) in a predetermined sequence of motions.

As further shown in FIG. 1, vaporizer device 100 may include mouthpiece component 110. In some non-limiting embodiments, mouthpiece component 110 may extend from first housing portion 150 of vaporizer device 100. As further shown in FIG. 1, first housing portion 150 of vaporizer device 100 may include air openings 120. In some non-limiting embodiments, air openings 120 allow air to enter an interior of vaporizer device 100 to mix with the aerosol as the aerosol is generated by components of vaporizer device 100. In some non-limiting embodiments, first housing portion 150 may include one or more air openings 120. Other details regarding a vaporizer device are disclosed in International Patent Application No. PCT/US2020/030477, entitled “System, Method, and Computer Program Product for Determining a Characteristic of a Susceptor” and filed on Apr. 29, 2020, and International Patent Application No. PCT/US2020/031846, entitled “Mechanisms for Preventing Ingestion of Liquid in Vaping Devices” and filed on May 7, 2020, which are incorporated herein by reference. Further details regarding a vaporizer device are disclosed in U.S. Pat. No. 10,201,185, entitled “Vaporizer Device” and issued on Feb. 12, 2019, which is incorporated herein by reference.

In some non-limiting embodiments, mouthpiece component 110 may extend from first housing portion 150. For example, first housing portion 150 may include mouthpiece component 110, and/or mouthpiece component 110 may be interchangeable. In some non-limiting embodiments, variants of mouthpiece component 110 may be designed such that mouthpiece component 110 may restrict airflow to reproduce a pulling sensation (e.g., similar to the sensation users may prefer and/or be familiar with in respect to smoking cigarettes, cigars, pipes, etc.). In some non-limiting embodiments, mouthpiece component 110 may be associated with (e.g., coupled to, integrally formed with, etc.) first housing portion 150. For example, mouthpiece component 110 may be associated with first housing portion 150 and mouthpiece component 110 may be configured to enable air to flow from an opening defined in mouthpiece component 110 to an area outside of vaporizer device 100. In some non-limiting embodiments, first housing portion 150 may include mouthpiece component 110 (e.g., mouthpiece component 110 may be formed integrally with first housing portion 150).

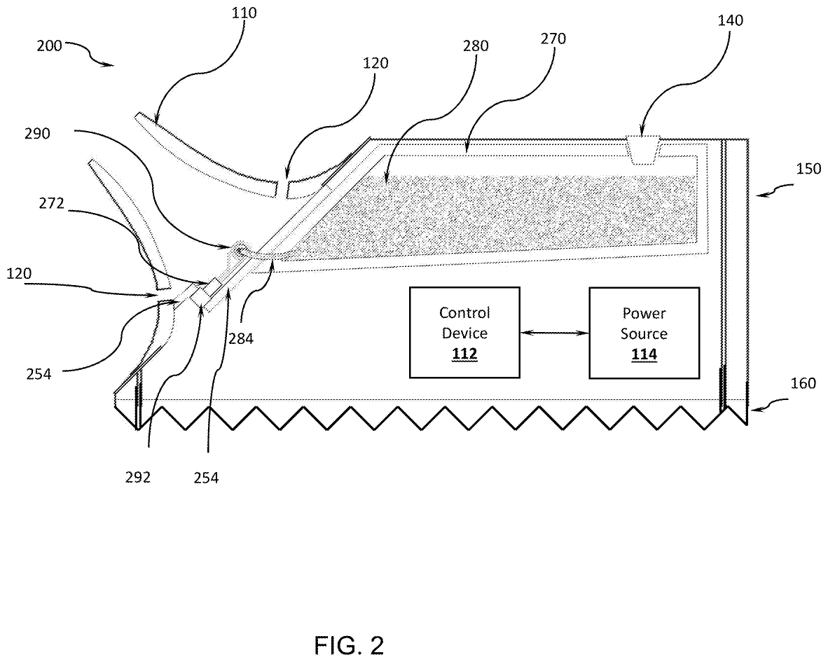

FIG. 2 is a diagram of a non-limiting embodiment of an implementation 200 of vaporizer device 100 shown in FIG. 1. It is noted that all components of implementation 200 shown in FIG. 2 are not required in each and every embodiment of vaporizer device 100 but the components of implementation 200 are shown in FIG. 2 for purposes of complete illustration. As shown in FIG. 2, implementation 200 includes control device 112, power source 114, mouthpiece component 110, air opening 120, stopper 140, first housing portion 150, second housing portion 160, reservoir 270, transducer element 272, aerosolizable substance 280, wick element 284, resistive heating element 290, support 292, and frame 254.

In some non-limiting embodiments, reservoir 270 may contain aerosolizable substance 280. Additionally or alternatively, wick element 284 and resistive heating element 290 may be used to aerosolize aerosolizable substance 280. For example, aerosolizable substance 280 may exit reservoir 270 via wick element 284 to be converted into an aerosol by resistive heating element 290 (e.g., when a current is flowing through resistive heating element 290). In some non-limiting embodiments, wick element 284 may include a component that is able to absorb aerosolizable substance 280 and to be heated to a point that an aerosol is generated from aerosolizable substance 280 but the component is not destroyed. For example, wick element 284 may be constructed from non-flammable and/or heat resistant materials. In some non-limiting embodiments, stopper 140 may seal reservoir 270. In some non-limiting embodiments, stopper 140 may not be present (e.g., if first housing portion 150 is a disposable capsule and/or the like).

In some non-limiting embodiments, resistive heating element 290 may include a resistive heating coil. Additionally or alternatively, resistive heating element 290 may be in contact with wick element 284, and/or wick element may be positioned within resistive heating element 290.

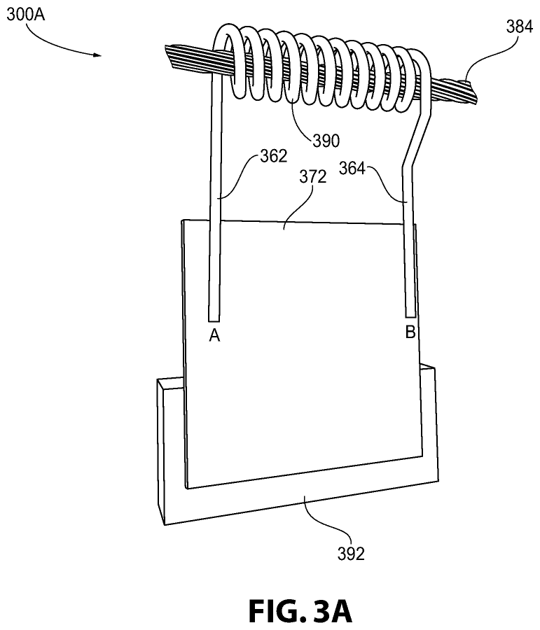

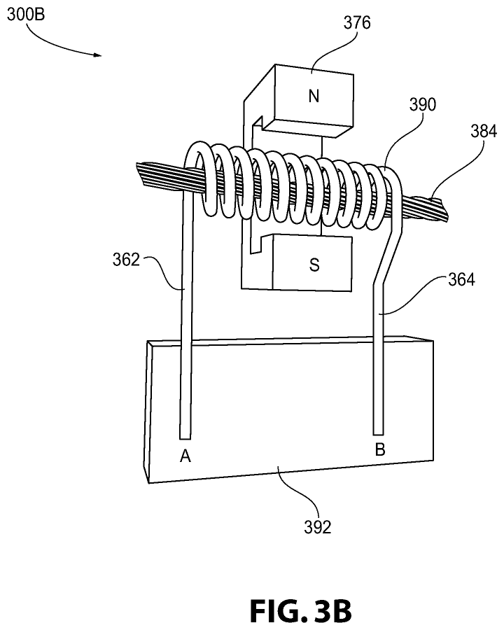

In some non-limiting embodiments, resistive heating element 290 may be attached to transducer element 272 (e.g., as further described below with reference to FIG. 3A), which may be attached to support 292. In some non-limiting embodiments, transducer element 272 may cause resistive heating element 290 to vibrate. For example, control device 112 may provide power from power source 114 to control transducer element 272 to vibrate resistive heating element 290. Additionally or alternatively, resistive heating element 290 may heat wick element 284 via conduction. For example, control device 112 may provide power from power source 114 to control resistive heating element 290 to heat wick element 284 via conduction. In some non-limiting embodiments, transducer element 272 may include a piezoelectric transducer.

In some non-limiting embodiments, support 292 may include a magnetic element (e.g., as further described below with reference to FIG. 3B). For example, the magnetic element may include a ferromagnetic material (e.g., a small permanent magnet material, such as a neodymium iron ferromagnet). In some non-limiting embodiments, the magnetic element may cause resistive heating element 290 to vibrate. In some non-limiting embodiments, resistive heating element 290 may heat wick element 284 via conduction.

In some non-limiting embodiments, frame 254 may be located within first housing portion 150. Additionally or alternatively, support 292 may be attached to frame 254. In some non-limiting embodiments, support 292 may hold transducer element 272 and resistive heating element 290 in a predetermined position within first housing portion 150 to allow resistive heating element 290 to heat wick element 284.

In some non-limiting embodiments, frame 254 may include a feedthrough that provides a seal around the electronic components (e.g., resistive heating element 290, wick element 284, wires connected thereto, and/or the like). In some non-limiting embodiments, at least two wires (e.g., a first wire and a second wire) may supply current through resistive heating element 290 (e.g., the resistive heating coil and/or the like), e.g., from power source 114 (e.g., directly or indirectly via control device 112). Additionally or alternatively, at least one additional wire (e.g., a third wire, third and fourth wires, and/or the like, the number of which may depend on the configuration of the grounding plane of transducer element 272 and/or the like) may drive the vibration of (e.g., provide a vibration signal to and/or the like) transducer element 272 attached to support 292.

In some non-limiting embodiments, various separatrices (not pictured) may direct airflow. For example, such separatrices may direct airflow to the vicinity of the region where the aerosol is generated (e.g., aerosolizable substance 280 is aerosolized) to ensure such airflow is large (e.g., with respect to a pressure drop of around 100 mm of water).

In some non-limiting embodiments, at least one end of (e.g., either end of, both ends of, and/or the like) wick element 284 may extend into reservoir 270 containing aerosolizable substance 280.

In some non-limiting embodiments, transducer element 272 may be selected to avoid a piezoelectric material that will de-pole at elevated temperatures. For example, a piezoelectric material for transducer element 272 may be selected so that the temperature range at which the viscosity is significantly lowered may be above 100 Centigrade, and a piezoelectric material may allow aerosol creation below the boiling point of aerosolizable substance 280.

The frequency of the movement (e.g., vibration) of resistive heating element 290 and/or wick element 284 may be selected to enhance (e.g., increase, maximize, and/or the like) aerosol production. For example, longer wires (e.g., coil legs, first and second wires for supplying current through resistive heating element 390, and/or the like) may reduce restoring force of resistive heating element 290 (or shorter wires may increase the restoring force), and the resonant frequency of resistive heating element 290 may, therefore, be adjusted.

In some non-limiting embodiments, larger sub-assemblies may be vibrated (e.g., first body portion 150, a whole capsule of vaporizer device 100, and/or the like) to aerosolize aerosolizable substance 280. Additionally or alternatively, vibration of such larger sub-assemblies may increase the energy required for vibration and, therefore, aerosolization.

In some non-limiting embodiments, control device 112 may include one or more devices capable of controlling power source 114 to provide power to one or more components (e.g., resistive heating element 290) of a vaporizer device (e.g., vaporizer device 100, implementation 200, and/or the like). For example, control device 112 may be configured to control an amount of heat provided by resistive heating element 290 to aerosolizable substance 280 in contact with resistive heating element 290 and/or wick element 284 based on at least one current provided to resistive heating element 290. Additionally or alternatively, control device 112 may be configured to control an amount (e.g., amplitude, frequency, and/or the like) of movement (e.g., vibration) of resistive heating element 290 and/or wick element 284 based on at least one current provided to transducer element 272. In some non-limiting embodiments, control device 112 may include a computing device, such as a computer, a processor, a microprocessor, a controller, and/or the like. In some non-limiting embodiments, control device 112 may include one or more electrical circuits that provide power conditioning for power provided by power source 114.

In some non-limiting embodiments, power source 114 includes one or more devices capable of providing power to resistive heating element 290, transducer element 272; and/or control device 112. For example, power source 114 may include an alternating current (AC) power supply (e.g., a generator, an alternator, and/or the like) and/or a direct current (DC) power supply (e.g., a battery, a capacitor, a fuel cell, and/or the like). In some non-limiting embodiments, power source 114 may be configured to provide power to one or more other components of vaporizer device 100. In some non-limiting embodiments, power source 114 includes one or more electrical circuits that provide power conditioning for power provided by power source 114.

FIG. 3A is a diagram of a non-limiting embodiment of an implementation 300A of vaporizer device 100 shown in FIG. 1. It is noted that all components of implementation 300A shown in FIG. 3A are not required in each and every embodiment of vaporizer device 100, but the components of implementation 300A are shown in FIG. 3A for purposes of complete illustration. As shown in FIG. 3A, implementation 300A includes support 392, transducer element 372, first wire 362, second wire 364, wick element 384, and resistive heating element 390. In some non-limiting embodiments, support 392 may be the same as or similar to support 292. In some non-limiting embodiments, transducer element 372 may be the same as or similar to transducer element 272. In some non-limiting embodiments, wick element 384 may be the same as or similar to wick element 284. In some non-limiting embodiments, resistive heating element 390 may be the same as or similar to resistive heating element 290.

In some non-limiting embodiments, resistive heating element 390 may include a resistive heating coil. Additionally or alternatively, resistive heating element 390 may be in contact with wick element 384, and/or wick element may be positioned within resistive heating element 390.

In some non-limiting embodiments, resistive heating element 390 may be attached (e.g., connected, clamped, and/or the like) to transducer element 372, which may be attached (e.g., connected, clamped, and/or the like) to support 392. In some non-limiting embodiments, transducer element 372 may cause resistive heating element 390 (and/or wick element 384) to vibrate. For example, control device 112 may provide power from power source 114 to control transducer element 372 to vibrate resistive heating element 390. Additionally or alternatively, resistive heating element 390 may heat wick element 384 via conduction. For example, control device 112 may provide power from power source 114 to control resistive heating element 390 to heat wick element 384 via conduction.

In some non-limiting embodiments, transducer element 372 may include a piezoelectric transducer (e.g., piezoelectric plate transducer and/or the like). For example, transducer element 372 (e.g., the piezoelectric transducer) may move (e.g., flex and/or the like) in response to a voltage (e.g., an alternating voltage, a changing voltage, and/or the like). Additionally or alternatively, the movement of transducer element 372 (e.g., the piezoelectric transducer) may shake resistive heating element 390 (and/or wick element 384) at the same frequency at which transducer element 372 moves (e.g., the frequency of the alternating voltage applied to transducer element 372 and/or the like), thereby causing resistive heating element 390 (and/or wick element 384) to vibrate. In some non-limiting embodiments, such vibration may increase the aerosolization (e.g., atomization and/or the like) of the heated aerosolizable substance (e.g., vaping liquid and/or the like) transported by wick element 384. In some non-limiting embodiments, the frequency of vibration may be ultrasonic. Additionally or alternatively, the frequency of vibration may be chosen to be a resonant frequency of resistive heating element 390, wick element 384, any combination thereof (e.g., heating element-wick element structure), and/or the like.

In some non-limiting embodiments, first wire 362 and/or second wire 364 may have the same wire gauge as resistive heating element 390 (e.g., the resistive heating coil). Additionally or alternatively, at least one of first wire 362 and/or second wire 364 may be made of a different wire gauge, a wire with different elastic properties, and/or the like, e.g., to tailor the resonant frequency of the structure (e.g., the combination of first wire 362, second wire 364, resistive heating element 390, and/or wick element 384). For example, the resonant frequency may be tailored (e.g., tuned and/or the like) to match a frequency at which transducer element 372 is efficient.

In some non-limiting embodiments, wick element 384 may be narrower in diameter than the inner diameter of resistive heating element 390 (e.g., the coil helix of resistive heating element 390). Additionally or alternatively, wick element 384 may fill the inner diameter of resistive heating element 390 (e.g., the coil helix of resistive heating element 390), which may enhance (e.g., increase, improve, and/or the like) thermal and/or mechanical coupling between wick element 384 and resistive heating element 390.

In some non-limiting embodiments, a current provided to resistive heating element 390 (e.g., the resistive heating coil) may be alternating current (AC) or direct current (DC).

FIG. 3B is a diagram of a non-limiting embodiment of an implementation 300B of vaporizer device 100 shown in FIG. 1. It is noted that all components of implementation 300B shown in FIG. 3B are not required in each and every embodiment of vaporizer device 100, but the components of implementation 300B are shown in FIG. 3B for purposes of complete illustration. As shown in FIG. 3B, implementation 300B includes support 392, magnetic element 376, first wire 362, second wire 364, wick element 384, and resistive heating element 390. In some non-limiting embodiments, support 392 may be the same as or similar to support 292. In some non-limiting embodiments, wick element 384 may be the same as or similar to wick element 284. In some non-limiting embodiments, resistive heating element 390 may be the same as or similar to heating element 290.

In some non-limiting embodiments, magnetic element 376 may cause resistive heating element 390 to vibrate. In some non-limiting embodiments, resistive heating element 390 may heat wick element 384 via conduction. In some non-limiting embodiments, magnetic element 376 may include a ferromagnetic material (e.g., a small permanent magnet, such as a neodymium iron ferromagnet and/or the like).

In some non-limiting embodiments, resistive heating element 390 may be immersed in a magnetic field due to magnetic element 376. Additionally or alternatively, when an AC current is passed through resistive heating element 390 (e.g., the resistive heating coil), resistive heating element 390 may experience a Lorentz force due to a current flowing in a conductor in a magnetic field, and/or the Lorentz force may cause resistive heating element 390 to vibrate (e.g., at the frequency of the AC current and/or the like).

In some non-limiting embodiments, magnetic element 376 may have any suitable shape, size, and/or dimensions and/or may include (e.g., be made of and/or the like) any suitable material. For example, magnetic element 376 may be a horseshoe-shaped magnet, a rectangular magnet, a parallelepiped magnet, and/or the like. In some non-limiting embodiments, magnetic element 376 may be attached to support 392. In some non-limiting embodiments, magnetic element 376 may have at least one of (e.g., either of, both of, and/or the like) the north pole or the south pole facing resistive heating element 390. For the purpose of illustration, magnetic element 376 may include an iron neodymium magnet with an aspect ratio roughly the same as resistive heating element 390 (e.g., the resistive heating coil). Magnetic element 376 may be magnetized along one of the short directions of magnetic element 376, may be placed to the side of resistive heating element 390, and/or may be positioned with either the north pole or the south pole direction up (e.g., above resistive heating element 390 and/or the like).

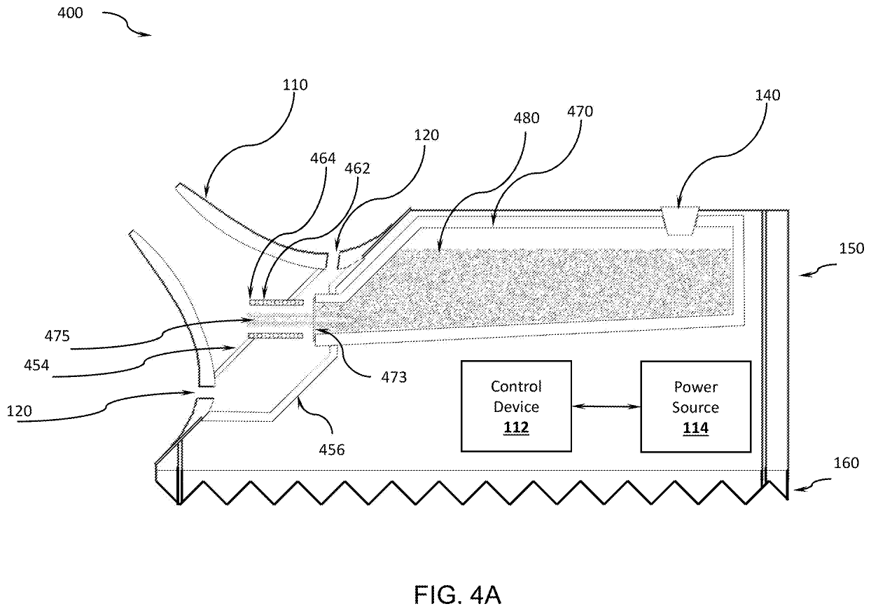

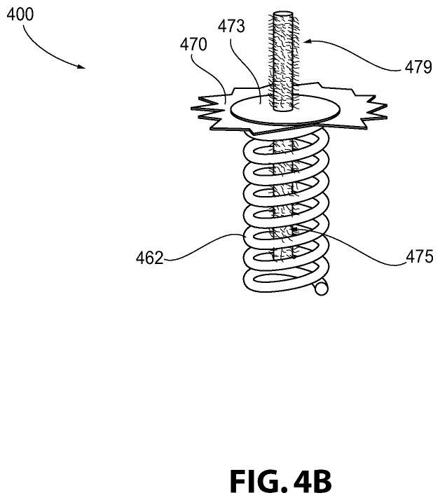

FIGS. 4A and 4B are diagrams of a non-limiting embodiment of an implementation 400 of vaporizer device 100 shown in FIG. 1. It is noted that all components of implementation 400 shown in FIGS. 4A and 4B are not required in each and every embodiment of vaporizer device 100, but the components of implementation 400 are shown in FIGS. 4A and 4B for purposes of complete illustration. As shown in FIGS. 4A and 4B, implementation 400 includes control device 112, power source 114, mouthpiece component 110, air opening 120, stopper 140, first housing portion 150, first frame 454, second frame 456, second housing portion 160, induction heating element 462, encapsulation element 464, reservoir 470, membrane diaphragm 473, susceptor element 475, conductive filaments 479, and aerosolizable substance 480. In some non-limiting embodiments, reservoir 470 may be the same as or similar to reservoir 270. In some non-limiting embodiments, aerosolizable substance 480 may be the same as or similar to aerosolizable substance 280.

In some non-limiting embodiments, induction heating element 462 may include an induction heating coil. In some non-limiting embodiments, induction heating element 462 may cause susceptor element 475 to generate heat based on induction. For example, control device 112 may provide power from power source 114 to control induction heating element 462 to cause susceptor element 475 to generate heat based on induction. Additionally or alternatively, induction heating element 462 may cause susceptor element 475 to vibrate based on an AC magnetic field generated by induction heating element 462. For example, control device 112 may provide power from power source 114 to control induction heating element 462 to cause susceptor element 475 to vibrate based on the AC magnetic field.

In some non-limiting embodiments, susceptor element 475 may be coupled to membrane diaphragm 473. Additionally or alternatively, membrane diaphragm 473 may allow susceptor element 475 to vibrate when susceptor element 475 receives the AC magnetic field generated by induction heating element 462. In some non-limiting embodiments, susceptor element 475 may be constructed of a combination of materials and configured to be in contact with an aerosolizable substance to achieve an appropriate effect. For example, susceptor element 475 may include an interwoven cloth (or otherwise intimately mixed combination) of fine induction heating wires, strands, and/or threads with wicking wires, strands, and/or threads. Additionally or alternatively, susceptor element 475 may include materials that are combined in the form of a rope or foam, or suitably deployed thin sheets of material. In some non-limiting embodiments, susceptor element 475 may include rolled up alternating foils of material. Additionally or alternatively, susceptor element 475 may be surrounded (e.g., partially, completely, etc.) by induction heating element 462, which may not necessarily be in contact with susceptor element 475. In some non-limiting embodiments, susceptor element 475 may include a mesh wick, and the mesh wick may be constructed of a material that is efficiently heated by induction (e.g., a FeCrAl alloy or ferritic stainless steel alloy). In some non-limiting embodiments, the mesh wick may be formed using a Kanthal mesh. Additionally or alternatively, susceptor element 475 may be removable from first housing portion 150 of vaporizer device 100 so that susceptor element 475 may be able to be cleaned, reused, and/or replaced separate from first housing portion 150 of vaporizer device 100.

In some non-limiting embodiments, membrane diaphragm 473 may be attached to an opening of reservoir 470. Additionally or alternatively, membrane diaphragm 473 may hold a first portion of susceptor element 475 within induction heating element 462 and a second portion of susceptor element 475 within reservoir 470.

In some non-limiting embodiments, membrane diaphragm 473 may include a first portion and a second portion attached to the first portion. Additionally or alternatively, the first portion of membrane diaphragm 473 may be coupled to susceptor element 475 and/or the second portion of membrane diaphragm 473 may be attached to the opening of reservoir 470.

In some non-limiting embodiments, induction heating element 462 may be encapsulated in encapsulation element 464. For example, encapsulation element 464 may include (e.g., be made of and/or the like) an inert material, such as a high temperature polymer, a glass, and/or the like.

In some non-limiting embodiments, at least one of induction heating element 462 and/or encapsulation element 464 may be attached to (e.g., supported by and/or the like) first frame 454. In some non-limiting embodiments, reservoir 470 may be attached to (e.g., supported by and/or the like) second frame 456.

In some non-limiting embodiments, susceptor element 475 may include a central portion and a plurality of conductive filaments 479 attached to the central portion. For example, susceptor element 475 with conductive filaments 479 may be used to provide many surfaces with relatively small dimensions and/or tight curvatures to thereby provide higher surface energy to aerosolize aerosolizable substance 480 (e.g., shed aerosol droplets of aerosolizable substance 480) when susceptor element 475 (with the conductive filaments 479) is coated with aerosolizable substance 480 (e.g.; vaping liquid and/or the like) of a suitable viscosity and caused to vibrate. In some non-limiting embodiments, susceptor element 475 (with conductive filaments 479) may be fabricated from a plurality of wires (e.g., 430 alloy stainless steel wires and/or the like) woven in a braid and then distressed to break, bend, and expose a fraction of the wires in the braid (e.g., to thereby provide conductive filaments 479). In some non-limiting embodiments, susceptor element 475 (e.g., the braid of wires) may be made of wires from 10 microns in diameter to 500 microns in diameter. For example, the wires may be from 50 microns to 100 microns in diameter. In some non-limiting embodiments, induction heating element 462 may provide both the heating energy (e.g., by causing susceptor element 475 to heat up in the AC magnetic field and/or the like) and a force on susceptor element 475 (e.g., to cause susceptor element 475 to vibrate in response to the AC magnetic field (e.g., provided that membrane diaphragm 473 attached to susceptor element 475 allows vibration). In some non-limiting embodiments, susceptor element 475 may be supported by at least one membrane diaphragm 473. In some non-limiting embodiments, membrane diaphragm 473 may include (e.g., be made of and/or the like) a silicone membrane.

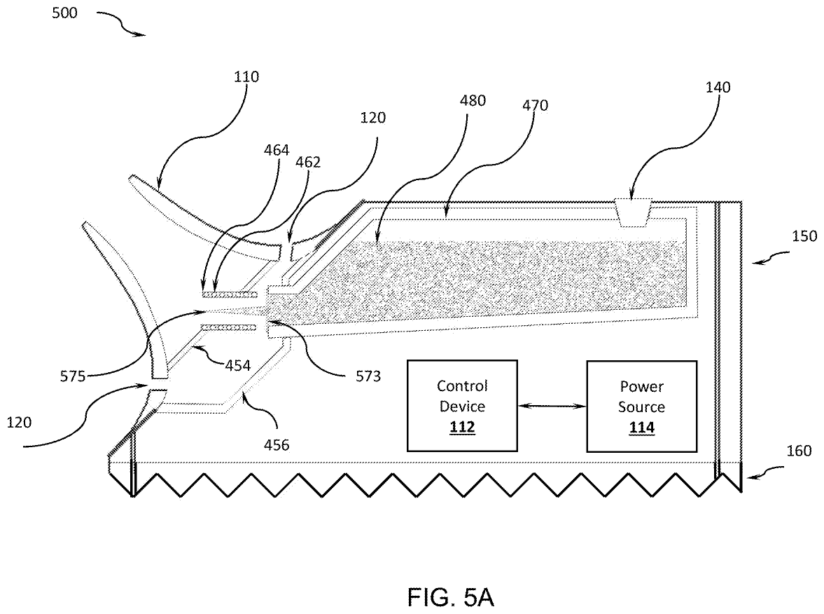

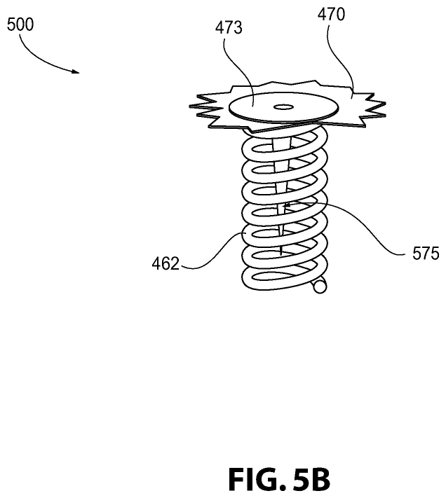

FIGS. 5A and 5B are diagrams of a non-limiting embodiment of an implementation 500 of vaporizer device 100 shown in FIG. 1. It is noted that all components of implementation 500 shown in FIGS. 5A and 5B are not required in each and every embodiment of vaporizer device 100, but the components of implementation 500 are shown in FIGS. 5A and 5B for purposes of complete illustration. As shown in FIGS. 5A and 5B, implementation 500 includes control device 112, power source 114, mouthpiece component 110, air opening 120, stopper 140, first housing portion 150, first frame 454, second frame 456, second housing portion 160, induction heating element 462, encapsulation element 464, reservoir 470, membrane diaphragm 573, susceptor element 575, and aerosolizable substance 480. In some non-limiting embodiments, membrane diaphragm 573 may be the same as or similar to membrane diaphragm 473.

In some non-limiting embodiments, susceptor element 575 may include a central portion having a conical shape. Additionally or alternatively, the central portion may be constructed from a foil defining (e.g., perforated with and/or the like) a plurality of apertures. In some non-limiting embodiments, susceptor element 575 may be constructed of a combination of materials and configured to be in contact with an aerosolizable substance to achieve an appropriate effect. For example, susceptor element 575 may include thin sheets of material. In some non-limiting embodiments, susceptor element 575 may include rolled up alternating foils of material. Additionally or alternatively, susceptor element 575 may be surrounded (e.g., partially, completely, etc.) by induction heating element 462, which may not necessarily be in contact with susceptor element 575. In some non-limiting embodiments, susceptor element 575 may be constructed of a material that is efficiently heated by induction (e.g., a FeCrAl alloy or ferritic stainless steel alloy). In some non-limiting embodiments, susceptor element 575 may be constructed of Kanthal foil. Additionally or alternatively, susceptor element 575 may be removable from first housing portion 150 of vaporizer device 100 so that susceptor element 575 may be able to be cleaned, reused, and/or replaced separate from first housing portion 150 of vaporizer device 100.

In some non-limiting embodiments, membrane diaphragm 573 may be attached to an opening of reservoir 470. Additionally or alternatively, membrane diaphragm 573 may hold at least a portion of susceptor element 575 within induction heating element 462.

In some non-limiting embodiments, induction heating element 462 may cause susceptor element 575 to generate heat based on induction. For example, control device 112 may provide power from power source 114 to control induction heating element 462 to cause susceptor element 575 to generate heat based on induction. Additionally or alternatively, induction heating element 462 may cause susceptor element 575 to vibrate based on an AC magnetic field generated by induction heating element 462. For example, control device 112 may provide power from power source 114 to control induction heating element 462 to cause susceptor element 575 to vibrate. For example, the AC magnetic field due to an AC current in induction heating element 462 may provide both heating by induction and the mechanical vibration of susceptor element 575. In some non-limiting embodiments, susceptor element 575 may be constructed from a foil perforated by a plurality of apertures (e.g., an array of holes and/or the like), e.g., to thereby provide a mesh.

In some non-limiting embodiments, induction heating (e.g., of susceptor element 575 and/or susceptor element 475 by induction heating element 462) may operate using a magnetic field produced by an AC current (e.g., in induction heating element 462) operating at frequencies in the tens to hundreds of kHz, and the oscillating field (e.g., AC magnetic field) may cause vibration of a susceptor element (e.g., susceptor element 575 and/or susceptor element 475). In some non-limiting embodiments, as the magnetic field changes direction, the magnetization of the susceptor element (e.g., susceptor element 575 and/or susceptor element 475) may lag behind in time, which may cause the susceptor element (e.g., susceptor element 575 and/or susceptor element 475) to experience a force along the axis of induction heating element 462. Additionally or alternatively, the mass of the susceptor element (e.g., susceptor element 575 and/or susceptor element 475) and the restoring force of the membrane diaphragm (e.g., membrane diaphragm 473 and/or membrane diaphragm 573) may determine the resonant frequency of the susceptor element (e.g., susceptor element 575 and/or susceptor element 475). In some non-limiting embodiments, based on such masses and restoring forces, the enhancement of aerosolization may be sufficient operating at a resonant frequency of an induction heating circuit (e.g., an induction coil tank circuit). In some non-limiting embodiments, the aerosolization may be further enhanced if the susceptor element (e.g., susceptor element 575 and/or susceptor element 475) is excited at the mechanical resonant frequency (e.g., determined based on the restoring force of membrane diaphragm 473 and/or membrane diaphragm 573, the mass of susceptor element 475 and/or susceptor element 575, any combination thereof, and/or the like). Additionally or alternatively, if the mechanical resonant frequency is different than (e.g., below and/or the like) the operating frequency of the induction heating circuit and if excitement of the susceptor element (e.g., susceptor element 575 and/or susceptor element 475) at the mechanical resonance is desired, an additional AC current operating at the mechanical resonance may be added to the AC current operating at the resonant frequency of an induction heating circuit that includes induction heating element 462.

In some non-limiting embodiments, susceptor element 575 may include a sheet with apertures (e.g., holes, openings, and/or the like) sized in a range of 0.5 to 5 microns. Additionally or alternatively, susceptor element 575 may be vibrated with 1 to 5 microns in amplitude to create an aerosol of drops of aerosolizable substance 480 when susceptor element 575 is in contact with aerosolizable substance 480. For example, if susceptor element 575 includes a sheet having about 10,000 apertures each with a conical shape (e.g., like a volcano), such a susceptor element 575 may be vibrated by an ultrasonic transducer to produce an aerosol of aerosolizable substance 480 (e.g., an aqueous solution, a suspension, and/or the like) that can then be inhaled. In some non-limiting embodiments, the apertures in susceptor element 575 may be too small to be seen (e.g., visible to the naked eye and/or the like). In some non-limiting embodiments, the apertures may be about 20 microns apart and/or may be arranged in a hexagonal array.

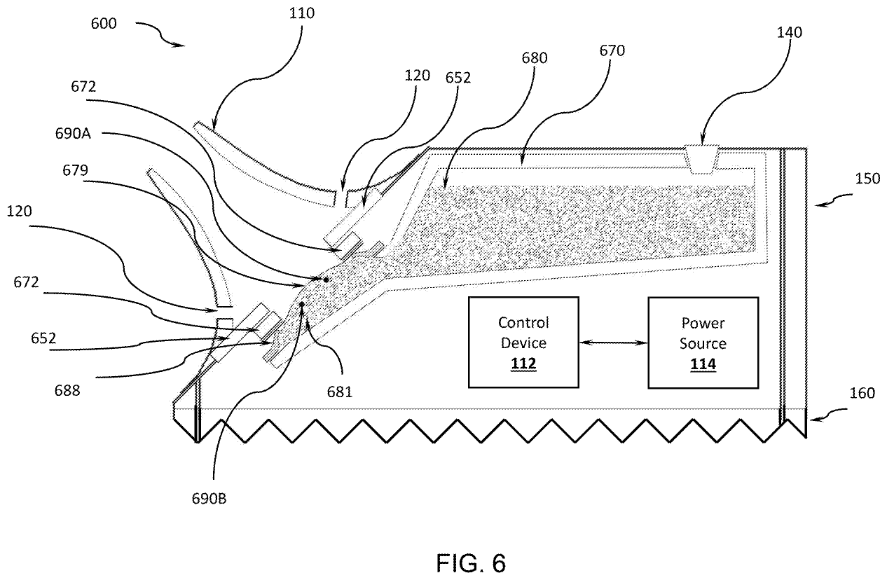

FIG. 6 is a diagram of a non-limiting embodiment of an implementation 600 of vaporizer device 100 shown in FIG. 1. It is noted that all components of implementation 600 shown in FIG. 6 are not required in each and every embodiment of vaporizer device 100, but the components of implementation 600 are shown in FIG. 6 for purposes of complete illustration. As shown in FIG. 6, implementation 600 includes control device 112, power source 114, mouthpiece component 110, air openings 120, stopper 140, first housing portion 150, second housing portion 160, reservoir 670, transducer element 672, cover assembly 679, aerosolizable substance 680, sub-reservoir 681, resistive heating elements 690A and 690B, support 652, and seal 688. In some non-limiting embodiments, reservoir 670 may be the same as or similar to reservoir 270 and/or reservoir 470. In some non-limiting embodiments, transducer element 672 may be the same as or similar to transducer element 272 and/or transducer element 372. In some non-limiting embodiments, aerosolizable substance 680 may be the same as or similar to aerosolizable substance 280 and/or aerosolizable substance 480. In some non-limiting embodiments, resistive heating elements 690A and/or 690B may be the same as or similar to resistive heating element 290 and/or resistive heating element 390.

In some non-limiting embodiments, transducer element 672 may be configured to vibrate cover assembly 679. For example, control device 112 may provide power from power source 114 to control transducer element 672 to vibrate cover assembly 679. In some non-limiting embodiments, transducer element 672 may be attached to support 652 and/or transducer element 672 may be attached to cover assembly 679. In some non-limiting embodiments, cover assembly 679 may include a surface with a plurality of apertures. For example, cover assembly 679 may be constructed from a foil that is perforated with a plurality of apertures. In some non-limiting embodiments, cover assembly 679 may include a mesh and/or a foil with etched holes (e.g., holes that are etched using lithography).

In some non-limiting embodiments, seal 688 may include a flexible material that seals an opening of reservoir 670 to prevent leakage of aerosolizable substance 680 from around the opening of reservoir 670. For example, seal 688 may include an elastomer. In some non-limiting embodiments, seal 688 is positioned between an opening of reservoir 670 (e.g., between a rim of reservoir 670 that defines the opening of reservoir 670) and cover assembly 679. In some non-limiting embodiments, seal 688 may have a shape that corresponds to the opening of reservoir 670. For example, seal 688 may have an annular shape that corresponds to an annular shape of the opening of reservoir 670. In some non-limiting embodiments, an edge of a first surface of cover assembly 679 may be attached to a first surface of transducer element 672 and a second surface of transducer element 672 may be attached rigidly to support 652. Additionally or alternatively, an edge of a second surface of cover assembly 679 may be attached to seal 688. In this way, cover assembly 679 may interface with aerosolizable substance 680 in reservoir 670 (e.g., sub-reservoir 681 of reservoir 670) so that cover assembly 679 is allowed to vibrate but aerosolizable substance 680 is prevented from leaking out from reservoir 670.

In some non-limiting embodiments, reservoir 670 may contain aerosolizable substance 680. In some non-limiting embodiments, cover assembly 679 and resistive heating elements 690A and 690B may be used to aerosolize aerosolizable substance 680. For example, cover assembly 679 may be positioned over the opening of reservoir 670 and aerosolizable substance 680 may exit reservoir 670 via the opening. Transducer element 672 may vibrate cover assembly 679 (e.g., may cause cover assembly 679 to vibrate) to atomize aerosolizable substance 680 and resistive heating elements 690A and 690B may heat (e.g., generate heat when a current is flowing through resistive heating elements 690A and 690B, as described herein) aerosolizable substance 680 to turn aerosolizable substance 680 into an aerosol. In some non-limiting embodiments, resistive heating elements 690A and 690B may heat aerosolizable substance 680 and transducer element 672 may vibrate cover assembly 679 to atomize aerosolizable substance 680 that has been heated by resistive heating elements 690A and 690B. In this way, the heat may reduce the viscosity of aerosolizable substance 680 so that aerosolizable substance 680, in contact with cover assembly 679, has a low enough viscosity for an aerosol to be created based on vibration of cover assembly 679.

In some non-limiting embodiments, resistive heating elements 690A and 690B may be positioned adjacent to an opening of reservoir 670. For example, resistive heating elements 690A and 690B may be positioned within sub-reservoir 681 of reservoir 670, where sub-reservoir 681 is adjacent the opening of reservoir 670. In some non-limiting embodiments, resistive heating elements 690A and 690B may include a resistive heating device, such as a resistive heating coil. Additionally or alternatively, resistive heating elements 690A and 690B may be positioned within (e.g., positioned at least partially within, positioned entirely within, etc.) reservoir 670 to be in contact with aerosolizable substance 680. For example, resistive heating elements 690A and 690B may be positioned within sub-reservoir 681 of reservoir 670 to be in contact with aerosolizable substance 680.

In some non-limiting embodiments, resistive heating elements 690A and 690B may be replaced by one or more individual heating elements. For example, resistive heating elements 690A and 690B may be replaced by a single heating element that has an annular shape (e.g., an annular shape that corresponds to an annular shape of cover assembly 679). In some non-limiting embodiments, resistive heating elements 690A and 690B may heat aerosolizable substance 680 via conduction (e.g., conductive heating, ohmic heating, etc.).

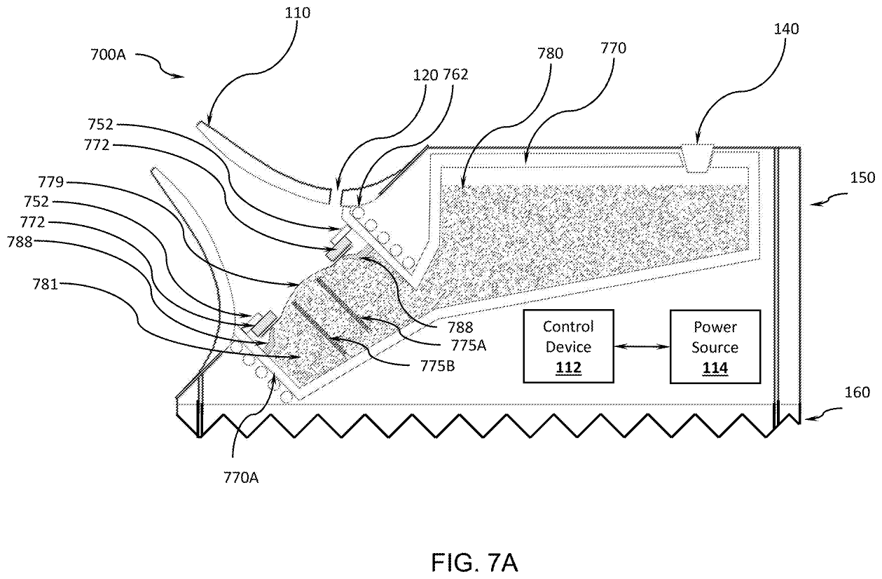

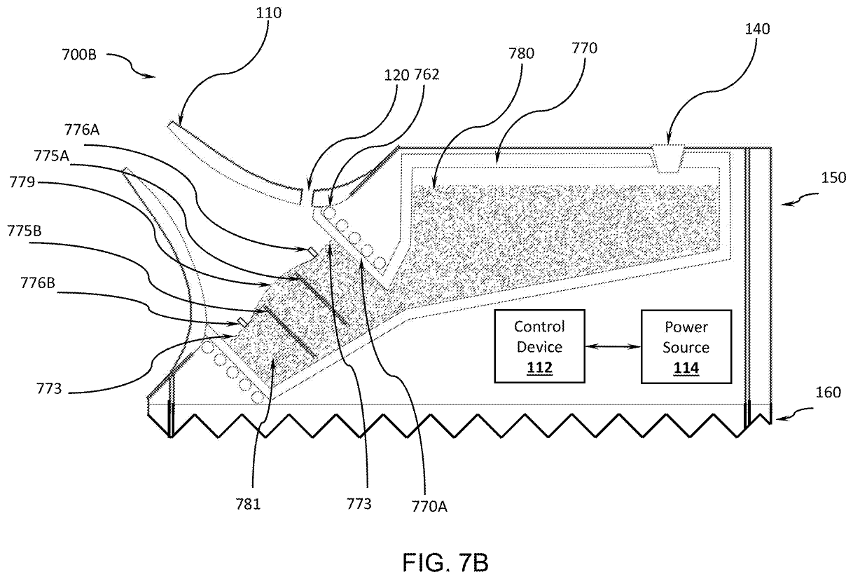

FIG. 7A is a diagram of a non-limiting embodiment of an implementation 700A of vaporizer device 100 shown in FIG. 1. It is noted that all components of implementation 700A shown in FIG. 7A are not required in each and every embodiment of vaporizer device 100, but the components of implementation 700A are shown in FIG. 7A for purposes of complete illustration. As shown in FIG. 7A, implementation 700A includes control device 112, power source 114, mouthpiece component 110, air openings 120, stopper 140, first housing portion 150, second housing portion 160, support 752, induction heating element 762, reservoir 770, transducer element 772, first susceptor element 775A, second susceptor element 775B, cover assembly 779, aerosolizable substance 780, sub-reservoir 781, and seal 788. In some non-limiting embodiments, support 752 may be the same as or similar to support 652. In some non-limiting embodiments, induction heating element 762 may be the same as or similar to induction heating element 462. In some non-limiting embodiments, reservoir 770 may be the same as or similar to reservoir 270, reservoir 470, and/or reservoir 670. In some non-limiting embodiments, transducer element 772 may be the same as or similar to transducer element 272, transducer element 372, and/or transducer element 672. In some non-limiting embodiments, first susceptor element 775A, may be the same as or similar to susceptor element 475 and/or susceptor element 575. In some non-limiting embodiments, second susceptor element 775B may be the same as or similar to susceptor element 475 and/or susceptor element 575. In some non-limiting embodiments, cover assembly 779 may be the same as or similar to cover assembly 679. In some non-limiting embodiments, aerosolizable substance 780 may be the same as or similar to aerosolizable substance 280, aerosolizable substance 480, and/or aerosolizable substance 680. In some non-limiting embodiments or aspects, sub-reservoir 781 may be the same as or similar to sub-reservoir 681. In some non-limiting embodiments, seal 788 may be the same as or similar to seal 688.

In some non-limiting embodiments, reservoir 770 may include (e.g., define and/or the like) an opening. Additionally or alternatively, cover assembly 779 may be positioned over the opening of reservoir 770. In some non-limiting embodiments, induction heating element 762 may be positioned adjacent an opening of reservoir 770. For example, induction heating element 762 may be positioned adjacent neck portion 770A of reservoir 770, where neck portion 770A defines the opening of reservoir 770. In some non-limiting embodiments, induction heating element 762 may be positioned around (e.g., surround, partially surround, etc.) neck portion 770A of reservoir 770. For example, induction heating element 762 may be positioned partially around or positioned entirely around neck portion 770A of reservoir 770. In some non-limiting embodiments, susceptor elements 775A and 775B and/or cover assembly 779 may be positioned within (e.g., positioned at least partially within, positioned entirely within, etc.) neck portion 770A of reservoir 770. In this way, susceptor elements 775A and 775B may positioned to most effectively receive an electromagnetic field produced by induction heating element 762.

In some non-limiting embodiments, induction heating element 762 may be positioned adjacent the opening of reservoir 770. Additionally or alternatively, induction heating element 762 may cause at least one susceptor element (e.g., first susceptor element 775A, second susceptor element 775B, and/or the like) to generate heat based on induction. For example, control device 112 may provide power from power source 114 to control induction heating element 762 that may cause the susceptor element(s) (e.g., first susceptor element 775A, second susceptor element 775B, and/or the like) to generate heat based on induction. In some non-limiting embodiments, induction heating element 762 may include an induction heating coil.

In some non-limiting embodiments, transducer element 772 may be configured to vibrate cover assembly 779. For example, control device 112 may provide power from power source 114 to control transducer element 772 to vibrate cover assembly 779. Additionally or alternatively, transducer element 772 may be attached to support 752 and/or transducer element 772 may be attached to cover assembly 779. In some non-limiting embodiments, implementation 700A may not include transducer element 772.

In some non-limiting embodiments, cover assembly 779 may vibrate based on an alternating electromagnetic field received by cover assembly 779 from induction heating element 762 independent of transducer element 772 (e.g., without transducer element 772). In some non-limiting embodiments, control device 112 may provide power from power source 114 to control induction heating element 762 to cause induction heating element 762 to generate an alternating electromagnetic field. The alternating electromagnetic field may be received by cover assembly 779 and the alternating electromagnetic field may cause cover assembly 779 to vibrate.

In some non-limiting embodiments, induction heating element 762 may cause the cover assembly to vibrate based on an AC magnetic field generated by induction heating element 762. For example, control device 112 may provide power from power source 114 to control induction heating element 762 to vibrate cover assembly 779.

In some non-limiting embodiments, cover assembly 779 may include a surface with a plurality of apertures. For example, cover assembly 779 may be constructed from a foil that is perforated with a plurality of apertures. In some non-limiting embodiments, cover assembly 679 may include a mesh and/or a foil with etched holes (e.g., holes that are etched using lithography).

In some non-limiting embodiments, seal 788 may be adjacent the opening of reservoir 770 (e.g., neck portion 770A of reservoir 770). Additionally or alternatively, seal 788 may be positioned between a rim of the opening of reservoir 770 and cover assembly 779.

In some non-limiting embodiments, cover assembly 779 may be coupled to reservoir 770 (e.g., neck portion 770A of reservoir 770). For example, an edge of cover assembly 779 may be attached to an interior surface of neck portion 770A of reservoir 770. In some non-limiting embodiments, cover assembly 779 may be coupled to reservoir 770 (e.g., neck portion 770A of reservoir 770) via seal 788. For example, an edge of cover assembly 779 may be attached to a first edge of seal 788 and a second edge of seal 788 may be attached to an interior surface of neck portion 770A of reservoir 770. Further, cover assembly 779 may interface with aerosolizable substance 780 in sub-reservoir 781 so that cover assembly 779 is allowed to vibrate but aerosolizable substance 780 is prevented from leaking out from sub-reservoir 781.

FIG. 7B is a diagram of a non-limiting embodiment of an implementation 700B of vaporizer device 100 shown in FIG. 1. It is noted that all components of implementation 700B shown in FIG. 7B are not required in each and every embodiment of vaporizer device 100, but the components of implementation 700B are shown in FIG. 78 for purposes of complete illustration. As shown in FIG. 7B, implementation 700B includes control device 112, power source 114, mouthpiece component 110, air openings 120, stopper 140, first housing portion 150, second housing portion 160, induction heating element 762, reservoir 770, susceptor elements 775A and 775B, magnetic elements 776A and 776B, cover assembly 779, aerosolizable substance 780, and flexible membrane 773. In some non-limiting embodiments, reservoir 770 may be the same as or similar to reservoir 270, reservoir 470, reservoir 670. In some non-limiting embodiments, induction heating element 762 may be the same as or similar to induction heating element 462. In some non-limiting embodiments, susceptor elements 775A and 7758 may be the same as or similar to susceptor element 475 and/or susceptor element 575. In some non-limiting embodiments, magnetic elements 776A and 776B may be the same as or similar to magnetic element 376. In some non-limiting embodiments, cover assembly 779 may be the same as or similar to cover assembly 679. In some non-limiting embodiments, aerosolizable substance 680 may be the same as or similar to aerosolizable substance 280, aerosolizable substance 480, and/or aerosolizable substance 680.

In some non-limiting embodiments, induction heating element 762 may be positioned adjacent an opening of reservoir 770. For example, induction heating element 762 may be positioned adjacent neck portion 770A of reservoir 770, where neck portion 770A defines the opening of reservoir 770. In some non-limiting embodiments, induction heating element 762 may be positioned around (e.g., surround, partially surround, etc.) neck portion 770A of reservoir 770. For example, induction heating element 762 may be positioned partially around or positioned entirely around neck portion 770A of reservoir 770. In some non-limiting embodiments, magnetic elements 776A and 776B, susceptor elements 775A and 775B, and/or cover assembly 779 may be positioned within (e.g., positioned at least partially within, positioned entirely within, etc.) neck portion 770A of reservoir 770. In this way, magnetic elements 776A and 776B and/or susceptor elements 775A and 775B may be positioned to most effectively receive an electromagnetic field produced by induction heating element 762.

In some non-limiting embodiments, reservoir 770 may contain aerosolizable substance 780. In some non-limiting embodiments, cover assembly 779 and susceptor elements 775A and 775B may be used to aerosolize aerosolizable substance 780. For example, cover assembly 779 may be positioned over an opening of reservoir 770 and aerosolizable substance 780 may exit reservoir 770 via the opening. Induction heating element 762 may cause cover assembly 779 to vibrate based on magnetic elements 776A and 776B (e.g., based on magnetic elements 776A and 776B receiving an electromagnetic field generated by induction heating element 762), which atomizes aerosolizable substance 780 and/or susceptor elements 775A and 775B and may heat (e.g., generate heat when susceptor elements 775A and 775B receive an electromagnetic field generated by induction heating element 762, as described herein) aerosolizable substance 780 to turn aerosolizable substance 780 into an aerosol. In some non-limiting embodiments, susceptor elements 775A and 775B may heat aerosolizable substance 780 and cover assembly 779 may vibrate to atomize aerosolizable substance 780 that has been heated by susceptor elements 775A and 7758. In this way, the heat may reduce the viscosity of aerosolizable substance 780 so that aerosolizable substance 780, in contact with cover assembly 779, has a low enough viscosity for an aerosol to be created based on vibration of cover assembly 779. Further, the source of heat together with the source of vibration are used but the same source of energy, an alternating current electromagnetic field produced by an AC electric current through one or more induction heating elements of induction heating element assembly 762, is used to control both the heat and the vibration. In this way, a more compact and simpler (e.g., less components) vaporizer device may be produced. In some non-limiting embodiments, frequencies (e.g., one or more frequencies of an alternating electrical current provided to induction heating element 762) used for causing vibration of cover assembly 779 and generating heat via induction may be in the range of 50 kHz to 300 kHz. For example, frequencies in the range of 100 kHz to 200 kHz may be used.

In some non-limiting embodiments, cover assembly 779 may be coupled to reservoir 770 (e.g., neck portion 770A of reservoir 770). For example, an edge of cover assembly 779 may be attached to an interior surface of neck portion 770A of reservoir 770. In some non-limiting embodiments, cover assembly 779 may be coupled to reservoir 770 (e.g., neck portion 770A of reservoir 770) via flexible membrane 773. For example, an edge of cover assembly 779 may be attached to a first edge of flexible membrane 773 and a second edge of flexible membrane 773 may be attached to an interior surface of neck portion 770A of reservoir 770. In this way, cover assembly 779 may be able to vibrate more freely than if cover assembly 779 is coupled to reservoir 770. Further, cover assembly 779 may interface with aerosolizable substance 780 in sub-reservoir 781 so that cover assembly 779 is allowed to vibrate but aerosolizable substance 780 is prevented from leaking out from sub-reservoir 781.

In some non-limiting embodiments, magnetic elements 776A and 776B may be coupled to (e.g., attached to) cover assembly 779. For example, magnetic elements 776A and 776B may be welded to cover assembly 779, adhered to cover assembly 779 with an adhesive, and/or may be positioned within apertures of cover assembly 779 to provide an interference fit. In some non-limiting embodiments, magnetic element 776A and/or 776B may include a permanent magnet. For example, magnetic element 776A and/or 7768 may include a permanent magnet that is sized and configured to fit within neck portion 770A of reservoir 770 and to receive an alternating current electromagnetic field that is generated by induction heating element 762.

In some non-limiting embodiments, induction heating element 762 is configured to cause cover assembly 779 to vibrate based on an alternating current magnetic field generated by the induction heating element 762. For example, cover assembly 779 may vibrate based on magnetic elements 776A and 776B receiving the alternating current electromagnetic field generated by induction heating element 762. The vibration of magnetic elements 776A and 776B may cause cover assembly 779 to vibrate. In some non-limiting embodiments, control device 112 may provide power from power source 114 to control induction heating element 762 to generate the alternating current electromagnetic field that causes magnetic elements 776A and 776B to vibrate.

In some non-limiting embodiments, cover assembly 779 may include a surface with a plurality of apertures. For example, cover assembly 779 may be constructed from a foil that is perforated with a plurality of apertures. In some non-limiting embodiments, cover assembly 779 may include a mesh and/or a foil with etched holes (e.g., holes that are etched using lithography). In some non-limiting embodiments, cover assembly 779 may be constructed from a material such as 430 alloy stainless steel. In some non-limiting embodiments, cover assembly 779 may be perforated with one or more apertures (e.g., volcano shaped apertures) in the range of 2 to 10 microns in size.

In some non-limiting embodiments, flexible membrane 773 may include a flexible material that seals an opening of reservoir 770 to prevent leakage of aerosolizable substance 780 from around the opening of reservoir 770 and that allows cover assembly 779 to vibrate. For example, flexible membrane 773 may include a seal and the seal may be constructed from an elastomer. In some non-limiting embodiments, flexible membrane 773 is positioned between neck portion 770A of reservoir 770 and cover assembly 779. In some non-limiting embodiments, flexible membrane 773 is positioned between a rim of neck portion 770A of reservoir 770 that defines the opening of reservoir 770 and cover assembly 779. In some non-limiting embodiments, flexible membrane 773 may have a shape that corresponds to the opening of reservoir 770. For example, flexible membrane 773 may have an annular shape that corresponds to an annular shape of the opening of reservoir 770 (e.g., to an annular shape of neck portion 770A of reservoir 770 that defines the opening).

In some non-limiting embodiments, susceptor elements 775A and 775B may be positioned adjacent to an opening of reservoir 770. For example, susceptor elements 775A and 775B may be positioned within sub-reservoir 781 of reservoir 770, where sub-reservoir 781 is adjacent the opening of reservoir 770. Additionally or alternatively, susceptor elements 775A and 775B may be positioned within (e.g., positioned at least partially within, positioned entirely within, etc.) reservoir 770 to be in contact with aerosolizable substance 780. For example, susceptor elements 775A and 775B may be positioned within sub-reservoir 781 of reservoir 770 to be in contact with aerosolizable substance 780. In some non-limiting embodiments, susceptor elements 775A and 775B may be mounted by one or more springs, such as a spring that includes a membrane (e.g., a silicone membrane).

In some non-limiting embodiments, susceptor elements 775A and 775B may be replaced by one or more individual susceptor elements. For example, susceptor elements 775A and 775B may be replaced by a single susceptor element that has an annular shape (e.g., an annular shape that corresponds to an annular shape of cover assembly 779). In some non-limiting embodiments, induction heating element 762 is configured to cause susceptor elements 775A and 775B to generate heat based on induction. In some non-limiting embodiments, susceptor element 775A and/or 775B may be constructed of a combination of materials and configured to be in contact with an aerosolizable substance to achieve an appropriate effect. For example, susceptor element 775A and/or 775B may include an interwoven cloth (or otherwise intimately mixed combination) of fine induction heating wires, strands, and/or threads with wicking wires, strands, and/or threads. Additionally or alternatively, susceptor element 775A and/or 775B may include materials that are combined in the form of a rope or foam, or suitably deployed thin sheets of material. In some non-limiting embodiments, susceptor element 775A and/or 775B may include rolled up alternating foils of material. Additionally or alternatively, susceptor element 775A and/or 775B may be surrounded (e.g., partially, completely, etc.) by induction heating element 762, which may not necessarily be in contact with susceptor element 775A and/or 775B. In some non-limiting embodiments, susceptor element 775A and/or 775B may include a mesh wick, and the mesh wick may be constructed of a material that is efficiently heated by induction (e.g., a FeCrAl alloy or ferritic stainless steel alloy). In some non-limiting embodiments, the mesh wick may be formed using a Kanthal mesh. Additionally or alternatively, susceptor element 775A and/or 775B may be removable from first housing portion 150 of vaporizer device 100 so that susceptor element 775A and/or 775B may be able to be cleaned, reused, and/or replaced separate from first housing portion 150 of vaporizer device 100.

In some non-limiting embodiments, magnetic elements 776A and 776B may be replaced by one or more individual magnetic elements. For example, magnetic elements 776A and 776B may be replaced by a single magnetic element that has an annular shape (e.g., an annular shape that corresponds to an annular shape of cover assembly 779). In some non-limiting embodiments, magnetic elements 776A and 776B may cause cover assembly 779 to vibrate based on an alternating current electromagnetic field generated by induction heating element 762.

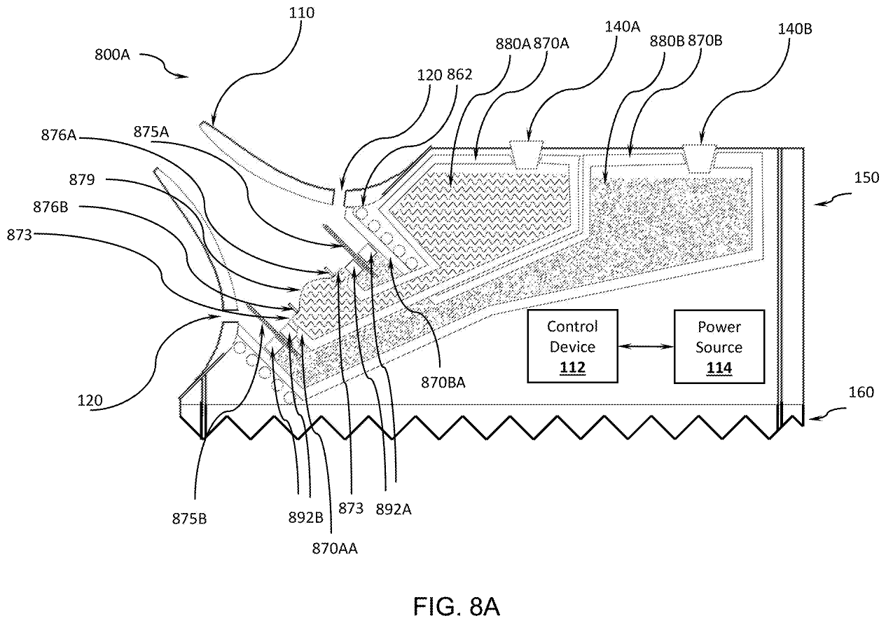

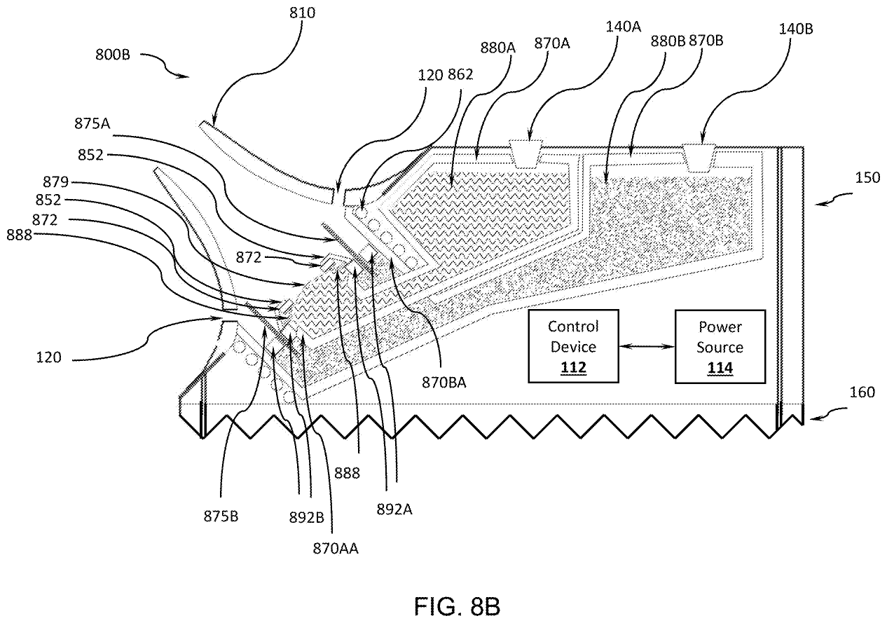

FIG. 8A is a diagram of a non-limiting embodiment of an implementation 800A of vaporizer device 100 shown in FIG. 1. It is noted that all components of implementation 800A shown in FIG. 8A are not required in each and every embodiment of vaporizer device 100, but the components of implementation 800A are shown in FIG. 8A for purposes of complete illustration. As shown in FIG. 8A, implementation 800A includes control device 112, power source 114, mouthpiece component 110, air openings 120, first stopper 140A, second stopper 140B, first housing portion 150, second housing portion 160, induction heating element 862, first reservoir 870A, first neck portion 870AA, second reservoir 870B, second neck portion 870BA, flexible membrane 873, susceptor elements 875A and 8758, magnetic elements 876A and 876B, cover assembly 879, first aerosolizable substance 880A, second aerosolizable substance 880B, and supports 892A and 892B. In some non-limiting embodiments, first stopper 140A and/or second stopper 140B may be the same as or similar to stopper 140. In some non-limiting embodiments, induction heating element 862 may be the same as or similar to induction heating element 462 and/or induction heating element 762. In some non-limiting embodiments, first reservoir 870A and/or second reservoir 8708 may be the same as or similar to reservoir 270, reservoir 470, reservoir 670, and/or reservoir 770. In some non-limiting embodiments, first neck portion 870AA and/or second neck portion 870BA may be the same as or similar to neck portion 770A. In some non-limiting embodiments, flexible membrane 873 may be the same as or similar to membrane diaphragm 473, membrane diaphragm 573, and/or flexible membrane 773. In some non-limiting embodiments, susceptor elements 875A and 8758 may be the same as or similar to susceptor element 475, susceptor element 575, and/or susceptor elements 775A and 775B. In some non-limiting embodiments, magnetic elements 876A and 876B may be the same as or similar to magnetic element 376 and/or magnetic elements 776A and 776B. In some non-limiting embodiments, cover assembly 879 may be the same as or similar to cover assembly 679 and/or cover assembly 779. In some non-limiting embodiments, first aerosolizable substance 880A and/or second aerosolizable substance 880B may be the same as or similar to aerosolizable substance 280, aerosolizable substance 480, aerosolizable substance 680, and/or aerosolizable substance 780. In some non-limiting embodiments, supports 892A and 892B may be the same as or similar to support 292, and/or support 392.

In some non-limiting embodiments, implementation 800A of vaporizer device 100 may include two reservoirs. For example, implementation 800A of vaporizer device 100 may include first reservoir 870A and second reservoir 870B. Additionally or alternatively, first reservoir 870A and second reservoir 870B may contain first aerosolizable substance 880A and second aerosolizable substance 880B, respectively. In some non-limiting embodiments, first aerosolizable substance 880A may be aerosolized in a different way than second aerosolizable substance 880B. For example, first aerosolizable substance 880A may include a nicotine containing e-liquid as an aerosolizable substance, and second aerosolizable substance 880B may include a flavored water-based solution (e.g., the combined aerosol may be flavored based on second aerosolizable substance 880B (e.g., a cooling water-based aerosol) that has not been exposed to the high temperatures required to aerosolize first aerosolizable substance 880A). As such, the combined aerosol may be a cooler aerosol that is flavored with compounds that might otherwise degrade at high temperatures. In some non-limiting embodiments, both heating and vibration may use the same energy source, e.g., an AC magnetic field provided by an alternating current in induction heating element 862. For example, control device 112 may provide power from power source 114 to control induction heating element 862 to heat susceptor elements 875A and 875B by induction. Additionally or alternatively, control device 112 may provide power from power source 114 to control induction heating element 862 to cause magnetic elements 876A and 876B positioned on cover assembly 879 to experience an alternating force causing cover assembly 879 to vibrate. In some non-limiting embodiments, cover assembly 879 may be supported in a manner that permits cover assembly 879 to vibrate, e.g., supported by flexible membrane 873 (e.g., an elastomer, such as a silicon elastomer).

In some non-limiting embodiments, any suitable combination of the aerosolization techniques described herein may be used to aerosolize either and/or both of first aerosolizable substance 880A and/or second aerosolizable substance 880B.

In some non-limiting embodiments, the magnetic elements described herein (e.g., magnetic element 376, magnetic elements 776A and 776B, and/or magnetic elements 876A and 876B) may be permanent magnets (e.g., hard ferromagnets and/or the like). Additionally or alternatively, the magnetic elements described herein (e.g., magnetic element 376, magnetic elements 776A and 776B, and/or magnetic elements 876A and 876B) may be electromagnets. For example, such an electromagnet may include at least one coil of thin wire that is excited by current in the opposite sense (e.g., opposite direction and/or the like) of the induction heating coil (e.g., induction heating element 462, induction heating element 762, and/or induction heating element 862), which may produce a force that can be controlled by the magnitude (e.g., amplitude and/or the like) of the current through the electromagnet and/or the induction heating coil. In such an example, although such use of electromagnets may be relatively more complex (e.g., using more components) than permanent magnets, the amount of force imparted on the magnetic elements may be more flexible (e.g., selectable, tunable, tailorable, and/or the like).

In some non-limiting embodiments, induction heating element 862 may be positioned adjacent an opening of at least one of first reservoir 870A and/or second reservoir 870B. For example, induction heating element 862 may be positioned adjacent at least one of first neck portion 870AA of first reservoir 870A and/or second neck portion 870BA of second reservoir 870B. Additionally or alternatively, first neck portion 870AA and second neck portion 870BA may define the openings of first reservoir 870A and second reservoir 870B, respectively. In some non-limiting embodiments, induction heating element 862 may be positioned around (e.g., surround, partially surround, etc.) first neck portion 870AA and/or second neck portion 870BA. For example, induction heating element 862 may be positioned partially around or positioned entirely around both first neck portion 870AA and second neck portion 870BA. In some non-limiting embodiments, magnetic elements 876A and 876B, susceptor elements 875A and 875B, and/or cover assembly 879 may be positioned within (e.g.; positioned at least partially within, positioned entirely within, etc.) at least one of first neck portion 870AA and/or second neck portion 870BA. For example, as shown in FIG. 8A, susceptor elements 875A and 875B may be positioned within (e.g., positioned at least partially within, positioned entirely within, etc.) first neck portion 870AA, second neck portion 870BA may be positioned within (e.g., positioned at least partially within, positioned entirely within, etc.) first neck portion 870AA, and magnetic elements 876A and 876B and cover assembly 879 may be positioned within (e.g., positioned at least partially within, positioned entirely within, etc.) second neck portion 870BA. In this way, magnetic elements 876A and 876B and/or susceptor elements 875A and 875B may be positioned to most effectively receive an electromagnetic field produced by induction heating element 862.

In some non-limiting embodiments, susceptor elements 875A and 875B may be attached to supports 892A and 892B, respectively. In some non-limiting embodiments, supports 892A and 892B may be positioned over an opening of second reservoir 870B and second aerosolizable substance 880B may exit second reservoir 870B via susceptor elements 875A and 875B passing through supports 892A and 892B, respectively. For example, induction heating element 862 may heat susceptor elements 875A and 875B (e.g., generate heat when susceptor elements 875A and 875B receive an electromagnetic field generated by induction heating element 862, as described herein), which may aerosolize second aerosolizable substance 880B to turn aerosolizable substance 880B into an aerosol. In some non-limiting embodiments, control device 112 may provide power from power source 114 to control induction heating element 862 to generate the AC electromagnetic field that heats susceptor elements 875A and 875B by induction.

In some non-limiting embodiments, cover assembly 879 and magnetic elements 876A and 876B may be used to aerosolize first aerosolizable substance 880A. For example, cover assembly 879 may be positioned over an opening of first reservoir 870A and first aerosolizable substance 880A may exit first reservoir 870A via the opening. For example, induction heating element 862 may cause cover assembly 879 to vibrate based on magnetic elements 876A and 876B (e.g., based on magnetic elements 876A and 876B receiving an electromagnetic field generated by induction heating element 862), which may atomize first aerosolizable substance 880A. Additionally or alternatively, cover assembly 879 may vibrate to atomize first aerosolizable substance 880A. In some non-limiting embodiments, the viscosity of first aerosolizable substance 880A may be sufficient (e.g., sufficiently low) to allow first aerosolizable substance 880A in contact with cover assembly 879 to be turned into an aerosol based on vibration of cover assembly 879. In some non-limiting embodiments, control device 112 may provide power from power source 114 to control induction heating element 862 to generate the AC electromagnetic field that imparts forces on magnetic elements 876A and 876B to cause vibration of cover assembly 879.

In some non-limiting embodiments, cover assembly 879 may be coupled to first reservoir 870A (e.g., first neck portion 870AA of first reservoir 870A). For example, cover assembly 879 may be coupled to first reservoir 870A via flexible membrane 873. In this way, cover assembly 879 may be able to vibrate more freely than if cover assembly 879 is coupled to first reservoir 870A directly.

In some non-limiting embodiments, magnetic elements 876A and 876B may be coupled to (e.g., attached to) cover assembly 879. In some non-limiting embodiments, at least one of magnetic elements 876A and/or 876B may include a permanent magnet.

In some non-limiting embodiments, induction heating element 862 may be configured to cause cover assembly 879 to vibrate based on an alternating current magnetic field generated by the induction heating element 862. For example, control device 112 may provide power from power source 114 to control induction heating element 862 to generate the AC electromagnetic field that causes magnetic elements 876A and 876B to vibrate.

In some non-limiting embodiments, cover assembly 879 may include a surface with a plurality of apertures. In some non-limiting embodiments, cover assembly 879 may be constructed from a material, such as 430 alloy stainless steel.

In some non-limiting embodiments, flexible membrane 873 may include a flexible material that seals an opening of first reservoir 870A to prevent leakage of first aerosolizable substance 880A from around the opening of first reservoir 870A and that allows cover assembly 879 to vibrate. In some non-limiting embodiments, flexible membrane 873 may be positioned between first neck portion 870AA and cover assembly 879.

In some non-limiting embodiments, susceptor elements 875A and 875B may be positioned adjacent to an opening of second reservoir 870B. For example, susceptor elements 875A and 875B may be positioned within (e.g., positioned at least partially within, positioned entirely within, etc.) second reservoir 870B to be in contact with second aerosolizable substance 880B. In some non-limiting embodiments, susceptor elements 875A and 875B may be mounted by supports 892A and 892B, respectively.

In some non-limiting embodiments, susceptor elements 875A and 875B may be replaced by one or more individual susceptor elements. For example, susceptor elements 875A and 875B may be replaced by a single susceptor element that has an annular shape. In some non-limiting embodiments, induction heating element 862 may be configured to cause susceptor elements 875A and 875B to generate heat based on induction. In some non-limiting embodiments, susceptor element 875A and/or 875B may be constructed of a combination of materials and configured to be in contact with an aerosolizable substance to achieve an appropriate effect. For example, susceptor element 875A and/or 875B may include an interwoven cloth (or otherwise intimately mixed combination) of fine induction heating wires, strands, and/or threads with wicking wires, strands, and/or threads. Additionally or alternatively, susceptor element 875A and/or 875B may include materials that are combined in the form of a rope or foam, or suitably deployed thin sheets of material. In some non-limiting embodiments, susceptor element 875A and/or 875B may include rolled up alternating foils of material. Additionally or alternatively, susceptor element 875A and/or 875B may be surrounded (e.g., partially, completely, etc.) by induction heating element 762, which may not necessarily be in contact with susceptor element 875A and/or 875B. In some non-limiting embodiments, susceptor element 875A and/or 875B may include a mesh wick, and the mesh wick may be constructed of a material that is efficiently heated by induction (e.g., a FeCrAl alloy or ferritic stainless steel alloy). In some non-limiting embodiments, the mesh wick may be formed using a Kanthal mesh. Additionally or alternatively, susceptor element 875A and/or 875B may be removable from first housing portion 150 of vaporizer device 100 so that susceptor element 875A and/or 875B may be able to be cleaned, reused, and/or replaced separate from first housing portion 150 of vaporizer device 100.

In some non-limiting embodiments, magnetic elements 876A and 876B may be replaced by one or more individual magnetic elements. For example, magnetic elements 876A and 876B may be replaced by a single magnetic element that has an annular shape. In some non-limiting embodiments, magnetic elements 876A and 876B may cause cover assembly 879 to vibrate based on an AC electromagnetic field generated by induction heating element 862.

FIG. 8B is a diagram of a non-limiting embodiment of an implementation 800B of vaporizer device 100 shown in FIG. 1. It is noted that all components of implementation 800B shown in FIG. 8B are not required in each and every embodiment of vaporizer device 100, but the components of implementation 800B are shown in FIG. 8B for purposes of complete illustration. As shown in FIG. 8B, implementation 800B includes control device 112, power source 114, mouthpiece component 110, air openings 120, first stopper 140A, second stopper 140B, first housing portion 150, second housing portion 160, support 852, induction heating element 862, first reservoir 870A, first neck portion 870AA, second reservoir 870B, second neck portion 870BA, transducer element 872, susceptor elements 875A and 875B, cover assembly 879, first aerosolizable substance 880A, second aerosolizable substance 880B, seal 888, and supports 892A and 892B. In some non-limiting embodiments, first stopper 140A and/or second stopper 140B may be the same as or similar to stopper 140. In some non-limiting embodiments, support 852 may be the same as or similar to support 652 and/or support 752. In some non-limiting embodiments, induction heating element 862 may be the same as or similar to induction heating element 462 and/or induction heating element 762. In some non-limiting embodiments, first reservoir 870A and/or second reservoir 870B may be the same as or similar to reservoir 270, reservoir 470, reservoir 670, and/or reservoir 770. In some non-limiting embodiments, first neck portion 870AA and/or second neck portion 870BA may be the same as or similar to neck portion 770A. In some non-limiting embodiments, transducer element 872 may be the same as or similar to transducer element 272, transducer element 372, transducer element 672, and/or transducer element 772. In some non-limiting embodiments, susceptor elements 875A and 875B may be the same as or similar to susceptor element 475, susceptor element 575, and/or susceptor elements 775A and 775B. In some non-limiting embodiments, cover assembly 879 may be the same as or similar to cover assembly 679 and/or cover assembly 779. In some non-limiting embodiments, first aerosolizable substance 880A and/or second aerosolizable substance 880B may be the same as or similar to aerosolizable substance 280, aerosolizable substance 480, aerosolizable substance 680, and/or aerosolizable substance 780. In some non-limiting embodiments, seal 888 may be the same as or similar to seal 688 and/or seal 788. In some non-limiting embodiments, supports 892A and 892B may be the same as or similar to support 292, and/or support 392.

In some non-limiting embodiments, vaporizer device 100 may include two reservoirs, e.g., first reservoir 870A and second reservoir 870B, and first reservoir 870A and second reservoir 870B may contain first aerosolizable substance 880A and second aerosolizable substance 880B, respectively. In some non-limiting embodiments, first aerosolizable substance 880A may be aerosolized in a different way than second aerosolizable substance 880B. In some non-limiting embodiments, control device 112 may provide power from power source 114 to control induction heating element 862 to heat susceptor elements 875A and 875B by induction. Additionally or alternatively, control device 112 may provide power from power source 114 to control transducer element 872 to cause cover assembly 879 to vibrate. In some non-limiting embodiments, cover assembly 879 may be supported in a manner that permits cover assembly 879 to vibrate, e.g., supported by seal 888 and/or the like.

In some non-limiting embodiments, any suitable combination of the aerosolization techniques described herein may be used to aerosolize either and/or both of first aerosolizable substance 880A and/or second aerosolizable substance 880B.

In some non-limiting embodiments, transducer element 872 may be configured to vibrate cover assembly 879. For example, control device 112 may provide power from power source 114 to control transducer element 872 to vibrate cover assembly 879. Additionally or alternatively, transducer element 872 may be attached to support 852 and/or transducer element 872 may be attached to cover assembly 879. In some non-limiting embodiments, implementation 800A may not include transducer element 872.

In some non-limiting embodiments, induction heating element 862 may be positioned adjacent an opening of at least one of first reservoir 870A and/or second reservoir 870B. For example, induction heating element 862 may be positioned adjacent at least one of first neck portion 870AA of first reservoir 870A and/or second neck portion 870BA of second reservoir 870B. Additionally or alternatively, first neck portion 870AA and second neck portion 870BA may define the openings of first reservoir 870A and second reservoir 870B, respectively. In some non-limiting embodiments, induction heating element 862 may be positioned around (e.g., surround, partially surround, etc.) first neck portion 870AA and/or second neck portion 870BA. In some non-limiting embodiments, transducer element 872, susceptor elements 875A and 875B, and/or cover assembly 879 may be positioned within (e.g., positioned at least partially within, positioned entirely within, etc.) at least one of first neck portion 870AA and/or second neck portion 870BA. For example, as shown in FIG. 8B, susceptor elements 875A and 875B may be positioned within (e.g., positioned at least partially within, positioned entirely within, etc.) first neck portion 870AA, second neck portion 870BA may be positioned within (e.g., positioned at least partially within, positioned entirely within, etc.) first neck portion 870AA, and transducer element 872 and cover assembly 879 may be positioned within (e.g., positioned at least partially within, positioned entirely within, etc.) second neck portion 870BA. In this way, susceptor elements 875A and 875B may positioned to most effectively receive an electromagnetic field produced by induction heating element 862.

In some non-limiting embodiments, susceptor elements 875A and 875B may be attached to supports 892A and 892B, respectively. In some non-limiting embodiments, supports 892A and 8928 may be positioned over an opening of second reservoir 870B and second aerosolizable substance 880B may exit second reservoir 870B via susceptor elements 875A and 875B passing through supports 892A and 892B, respectively. For example, induction heating element 862 may heat susceptor elements 875A and 875B, which may aerosolize second aerosolizable substance 880B to turn aerosolizable substance 880B into an aerosol. In some non-limiting embodiments, control device 112 may provide power from power source 114 to control induction heating element 862 to generate the AC electromagnetic field that heats susceptor elements 875A and 875B by induction.

In some non-limiting embodiments, cover assembly 879 and transducer element 872 may be used to aerosolize first aerosolizable substance 880A. For example, cover assembly 879 may be positioned over an opening of first reservoir 870A and first aerosolizable substance 880A may exit first reservoir 870A via the opening. For example, transducer element 872 may cause cover assembly 879 to vibrate, which may atomize first aerosolizable substance 880A. Additionally or alternatively, cover assembly 879 may vibrate to atomize first aerosolizable substance 880A. In some non-limiting embodiments, control device 112 may provide power from power source 114 to control transducer element 872 to cause vibration of cover assembly 879.

In some non-limiting embodiments, cover assembly 879 may be coupled to first reservoir 870A (e.g., first neck portion 870AA of first reservoir 870A). For example, cover assembly 879 may be coupled to first reservoir 870A via seal 888. For example, seal 888 may be adjacent the opening of first reservoir 870A (e.g., first neck portion 870AA of first reservoir 870A). Additionally or alternatively, seal 888 may be positioned between a rim of the opening of first reservoir 870A and cover assembly 879. In some non-limiting embodiments, seal 888 is positioned between an opening of first reservoir 870A (e.g., between a rim of first reservoir 870A that defines the opening of first reservoir 870A) and cover assembly 879. In some non-limiting embodiments, seal 888 may have a shape that corresponds to the opening of first reservoir 870A. For example, seal 888 may have an annular shape that corresponds to an annular shape of the opening of first reservoir 870A. In some non-limiting embodiments, an edge of a first surface of cover assembly 879 may be attached to a first surface of transducer element 872 and a second surface of transducer element 872 may be attached rigidly to support 852. Additionally or alternatively, an edge of a second surface of cover assembly 879 may be attached to seal 888. In this way, cover assembly 879 may interface with aerosolizable substance 880A in first reservoir 870A so that cover assembly 879 is allowed to vibrate but aerosolizable substance 880A is prevented from leaking out from first reservoir 870A.

In some non-limiting embodiments, cover assembly 879 may include a surface with a plurality of apertures. In some non-limiting embodiments, cover assembly 879 may be constructed from a material, such as 430 alloy stainless steel.

In some non-limiting embodiments, susceptor elements 875A and 875B may be positioned adjacent to an opening of second reservoir 870B. For example, susceptor elements 875A and 875B may be positioned within (e.g., positioned at least partially within, positioned entirely within, etc.) second reservoir 870B to be in contact with second aerosolizable substance 880B. In some non-limiting embodiments, susceptor elements 875A and 875B may be mounted by supports 892A and 892B, respectively.

In some non-limiting embodiments, susceptor elements 875A and 875B may be replaced by one or more individual susceptor elements. For example, susceptor elements 875A and 875B may be replaced by a single susceptor element that has an annular shape. In some non-limiting embodiments, induction heating element 862 may be configured to cause susceptor elements 875A and 875B to generate heat based on induction.

In some non-limiting embodiments, transducer element 872 may include one or more individual transducer elements. For example, transducer element 872 may include a single transducer element that has an annular shape. In some non-limiting embodiments, transducer element 872 may cause cover assembly 879 to vibrate based on an AC current flowing through transducer element 872.

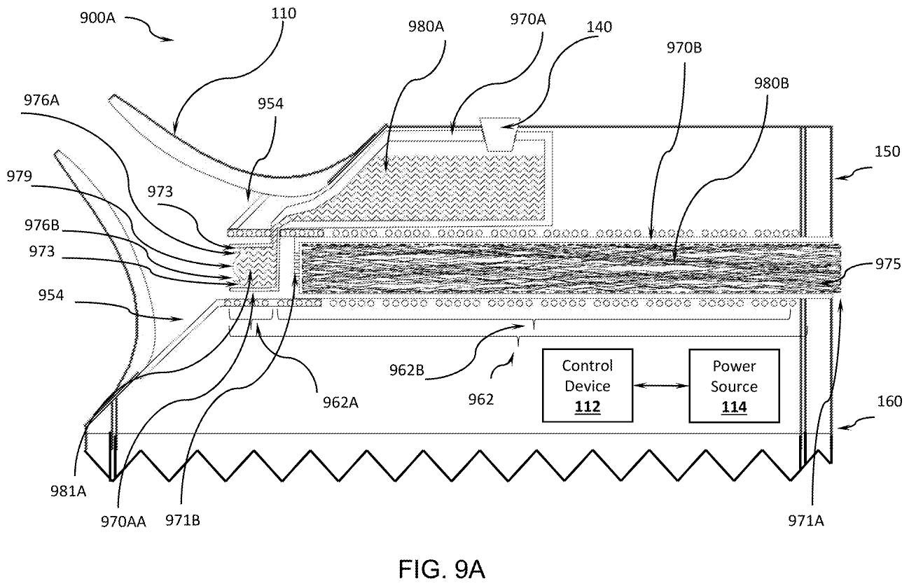

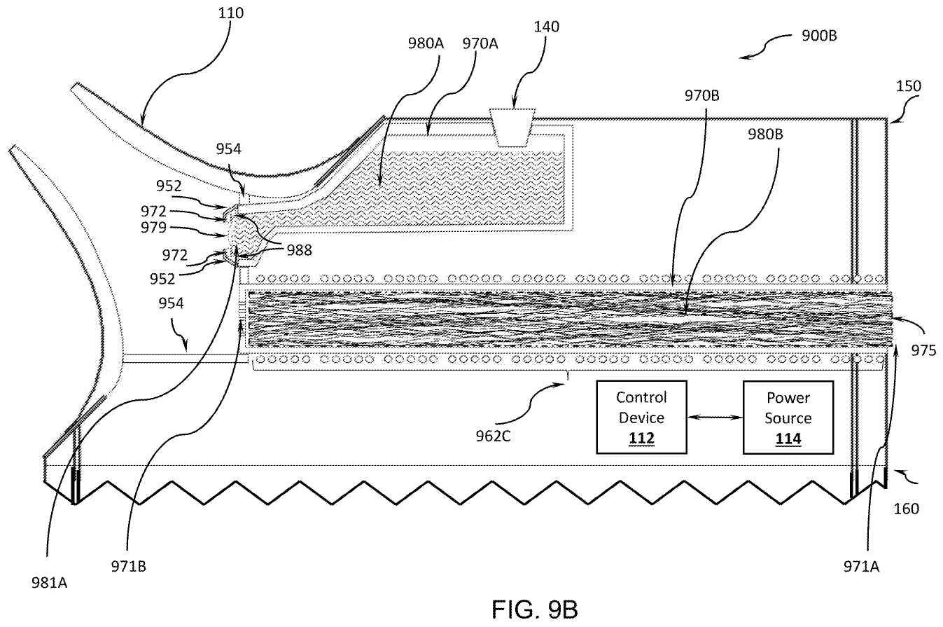

FIG. 9A is a diagram of a non-limiting embodiment of an implementation 900A of vaporizer device 100 shown in FIG. 1. It is noted that all components of implementation 900A shown in FIG. 9A are not required in each and every embodiment of vaporizer device 100, but the components of implementation 900A are shown in FIG. 9A for purposes of complete illustration. As shown in FIG. 9A, implementation 900A includes control device 112, power source 114, mouthpiece component 110, stopper 140, first housing portion 150, second housing portion 160, frame 954, induction heating element assembly 962, first reservoir 970A, second reservoir 970B, susceptor element 975, magnetic elements 976A and 976B, and cover assembly 979. In some non-limiting embodiments, frame 954 may be the same as or similar to frame 254, first frame 454, and/or second frame 456. In some non-limiting embodiments, induction heating element assembly 962 may be the same as or similar to induction heating element 462, induction heating element assembly 762, and/or induction heating element 862. For example, induction heating element 962A and induction heating elements 962B may be the same as or similar to induction heating element 462, induction heating element assembly 762, and/or induction heating element 862. In some non-limiting embodiments, first reservoir 970A and/or second reservoir 970B may be the same as or similar to reservoir 270, reservoir 470, reservoir 670, reservoir 770, reservoir 870A and/or reservoir 870B. In some non-limiting embodiments, susceptor element 975 may be the same as or similar to susceptor element 475, susceptor element 575, susceptor element 775A, susceptor element 775B, susceptor element 875A, and/or susceptor element 875B. In some non-limiting embodiments, cover assembly 979 may be the same as or similar to cover assembly 679, cover assembly 779, and/or cover assembly 879.

As further shown in FIG. 9A, first reservoir 980A may contain aerosolizable substance 980A and second reservoir 980B may contain aerosolizable substance 980B. In some non-limiting embodiments, aerosolizable substance 980A and aerosolizable substance 9808 may be the same as or similar to aerosolizable substance 280, aerosolizable substance 480, and/or aerosolizable substance 680, aerosolizable substance 780, aerosolizable substance 880A, and/or aerosolizable substance 880B.

In some non-limiting embodiments, induction heating element assembly 962 may include induction heating element 962A and induction heating elements 962B. For example, induction heating element assembly 962 may include induction heating element 962A that is positioned adjacent neck portion 970AA of first reservoir 970A, where neck portion 970AA defines the opening of reservoir 970A, and induction heating element assembly 962 may include induction heating elements 962B (e.g., a plurality of induction heating elements that do not include induction heating element 962A positioned adjacent neck portion 970AA of first reservoir 970A) positioned along a length of second reservoir 970B. In some non-limiting embodiments, induction heating element 962A may be positioned around (e.g., surround, partially surround, etc.) neck portion 970AA of first reservoir 970A. For example, induction heating element 962A may be positioned partially around or positioned entirely around neck portion 970AA of first reservoir 970A. In some non-limiting embodiments, one or more of induction heating elements 962B of induction heating element assembly 962 may be positioned around (e.g., surround, partially surround, etc.) second reservoir 970B. For example, all of induction heating elements 962B may be positioned around the length of second reservoir 970B. In some non-limiting embodiments, induction heating element 962A and/or one or more induction heating elements of induction heating elements 962B may include an induction heating coil.

In some non-limiting embodiments, control device 112 may provide power from power source 114 to control induction heating element 962A and/or induction heating element 962B to generate an alternating current electromagnetic field. For example, control device 112 may provide power from power source 114 to cause induction heating element 962A to generate an alternating current electromagnetic field. In such an example, control device 112 may provide power from power source 114 to cause induction heating elements 962B to generate an alternating current electromagnetic field separately from induction heating element 962A. In this way, a user may control vaporizer device 100 (e.g., control vaporizer device 100 via control device 112) to produce an aerosol based on vibration independently of producing an aerosol based on heating.

In some non-limiting embodiments, control device 112 may provide power from power source 114 to cause each induction heating element of induction heating elements 962B to generate an alternating current electromagnetic field separately from each other. For example, control device 112 may provide power from power source 114 to activate one or more induction heating elements of induction heating elements 962B separately from other induction heating elements to cause one or more induction heating elements to generate an alternating current electromagnetic field.

In some non-limiting embodiments, second reservoir 970B may include first end 971A and second end 971B. In some non-limiting embodiments, first end 971A may include an opening that is sized and configured to allow for insertion of susceptor element 975 within second reservoir 970B. In some non-limiting embodiments, second end 971B may include one or more apertures that are sized and configured to allow for an aerosol (e.g., an aerosol generated by susceptor element 975 heating aerosolizable substance 980B) to flow out of second reservoir 970B.

In some non-limiting embodiments, magnetic elements 976A and 976B and/or cover assembly 979 may be positioned within (e.g., positioned at least partially within, positioned entirely within, etc.) neck portion 970AA of reservoir 970A. In this way, magnetic elements 976A and 976B and/or cover assembly 979 may be positioned to most effectively receive an electromagnetic field produced by one or more inducting heating elements of induction heating element assembly 962.

In some non-limiting embodiments, first reservoir 970A may contain aerosolizable substance 980A. In some non-limiting embodiments, cover assembly 979 may be used to aerosolize aerosolizable substance 980A. For example, cover assembly 979 may be positioned over an opening of first reservoir 970A and an aerosol generated from aerosolizable substance 980A may exit first reservoir 970A via the opening. Induction heating element 962A may cause cover assembly 979 to vibrate based on magnetic elements 976A and 976B (e.g., based on magnetic elements 976A and 976B receiving an electromagnetic field generated by induction heating element 962A), which atomizes aerosolizable substance 980A into an aerosol.

In some non-limiting embodiments, cover assembly 979 may be coupled to reservoir 970A (e.g., neck portion 970AA of reservoir 970A). For example, an edge of cover assembly 979 may be attached to an interior surface of neck portion 970AA of reservoir 970. In some non-limiting embodiments, cover assembly 979 may be coupled to reservoir 970A (e.g., neck portion 970AA of reservoir 970A) via flexible membrane 973. For example, an edge of cover assembly 979 may be attached to a first edge of flexible membrane 973 and a second edge of flexible membrane 973 may be attached to an interior surface of neck portion 970AA of reservoir 970. In this way, cover assembly 979 may be able to vibrate more freely than if cover assembly 979 is coupled to reservoir 970A. Further, cover assembly 979 may interface with aerosolizable substance 980A in sub-reservoir 981A so that cover assembly 979 is allowed to vibrate but aerosolizable substance 980A is prevented from leaking out from sub-reservoir 981A.

In some non-limiting embodiments, flexible membrane 973 may include a flexible material that seals an opening of first reservoir 970A to prevent leakage of aerosolizable substance 980A from around the opening of first reservoir 970A and that allows cover assembly 979 to vibrate. For example, flexible membrane 973 may include a seal and the seal may be constructed from an elastomer. In some non-limiting embodiments, flexible membrane 973 is positioned between neck portion 970AA of first reservoir 970A and cover assembly 979. In some non-limiting embodiments, flexible membrane 973 is positioned between a rim of neck portion 970AA of first reservoir 970A, which defines the opening of first reservoir 970A, and cover assembly 979. In some non-limiting embodiments, flexible membrane 973 may have a shape that corresponds to the opening of first reservoir 970A. For example, flexible membrane 973 may have an annular shape that corresponds to an annular shape of the opening of first reservoir 970A (e.g., to an annular shape of neck portion 970AA of first reservoir 970A that defines the opening).

In some non-limiting embodiments, cover assembly 979 may include a surface with a plurality of apertures. For example, cover assembly 979 may be constructed from a foil that is perforated with a plurality of apertures. In some non-limiting embodiments, cover assembly 979 may include a mesh and/or a foil with etched holes (e.g., holes that are etched using lithography). In some non-limiting embodiments, cover assembly 979 may be constructed from a material such as 430 alloy stainless steel. In some non-limiting embodiments, cover assembly 979 may be perforated with one or more apertures (e.g., volcano shaped apertures) in the range of 2 to 10 microns in size.

In some non-limiting embodiments, magnetic elements 976A and 976B may be coupled to (e.g., attached to) cover assembly 979. For example, magnetic elements 976A and 976B may be welded to cover assembly 979, adhered to cover assembly 979 with an adhesive, and/or may be positioned within apertures of cover assembly 979 to provide an interference fit. In some non-limiting embodiments, magnetic element 976A and/or 976B may include a permanent magnet. For example, magnetic element 976A and/or 976B may include a permanent magnet that is sized and configured to fit within neck portion 970AA of first reservoir 970A and to receive an alternating current electromagnetic field that is generated by induction heating element 962A if induction heating element assembly 962. In some non-limiting embodiments, magnetic elements 976A and 976B may be replaced by one or more individual magnetic elements. For example, magnetic elements 976A and 976B may be replaced by a single magnetic element that has an annular shape (e.g., an annular shape that corresponds to an annular shape of cover assembly 979). In some non-limiting embodiments, magnetic elements 976A and 976B may cause cover assembly 979 to vibrate based on an alternating current electromagnetic field generated by induction heating element 962A.

In some non-limiting embodiments, induction heating element 962A is configured to cause cover assembly 979 to vibrate based on an alternating current magnetic field generated by the induction heating element 962A. For example, cover assembly 979 may vibrate based on magnetic elements 976A and 976B receiving the alternating current electromagnetic field generated by induction heating element 962A. The vibration of magnetic elements 976A and 976B may cause cover assembly 979 to vibrate. In some non-limiting embodiments, control device 112 may provide power from power source 114 to control induction heating element 962A to generate the alternating current electromagnetic field that causes magnetic elements 976A and 976B to vibrate.

In some non-limiting embodiments, susceptor element 975 may be positioned within second reservoir 970B. For example, susceptor element 975 may be positioned entirely within or at least partially within second reservoir 970B. Additionally or alternatively, susceptor element 975 may be saturated with aerosolizable substance 980B. In some non-limiting embodiments, susceptor element 975 may be saturated with aerosolizable substance 980B prior to susceptor element 975 being inserted into second reservoir 970B. In some non-limiting embodiments, susceptor element 975 may become saturated with aerosolizable substance 980B upon susceptor element 975 being inserted into second reservoir 970B. In some non-limiting embodiments, susceptor element 975 may be positioned within second reservoir 970B based on an interference fit. For example, susceptor element 975 may be positioned within second reservoir 970B based on an interference fit and a predetermined amount of force may be required to remove susceptor element 975 from second reservoir 970B. In some non-limiting embodiments, susceptor element 975 may be replaced by a plurality of individual susceptor elements. For example, susceptor element 975 may be replaced by a plurality of individual susceptor elements, wherein the plurality of susceptor elements are sized and configured to be positioned within second reservoir 970B when each of the plurality of individual susceptor elements are placed end to end.

In some non-limiting embodiments, susceptor element 975 may be constructed of a combination of materials and configured to be in contact with an aerosolizable substance to achieve an appropriate effect. For example, susceptor element 975 may include an interwoven cloth (or otherwise intimately mixed combination) of fine induction heating wires, strands, and/or threads with wicking wires, strands, and/or threads. Additionally or alternatively, susceptor element 975 may include materials that are combined in the form of a rope or foam, or suitably deployed thin sheets of material. In some non-limiting embodiments, susceptor element 975 may include rolled up alternating foils of material. Additionally or alternatively, susceptor element 975 may be surrounded (e.g., partially, completely, etc.) by induction heating element 462, which may not necessarily be in contact with susceptor element 975. In some non-limiting embodiments, susceptor element 975 may include a mesh wick, and the mesh wick may be constructed of a material that is efficiently heated by induction (e.g., a FeCrAl alloy or ferritic stainless steel alloy). In some non-limiting embodiments, the mesh wick may be formed using a Kanthal mesh. Additionally or alternatively, susceptor element 975 may be removable from first housing portion 150 of vaporizer device 100 so that susceptor element 975 may be able to be cleaned, reused, and/or replaced separate from first housing portion 150 of vaporizer device 100.

In some non-limiting embodiments, aerosolizable substance 980B may be different from aerosolizable substance 980A. For example, aerosolizable substance 980B may include an herbal material (e.g., a solid herbal material). In some non-limiting embodiments, aerosolizable substance 980B may include humectants (e.g. propylene glycol and/or glycerin) and/or supplemental nicotine. Additionally or alternatively, aerosolizable substance 980B may include material derived from plants, such as tobacco plants, cannabis plants, where legal, and/or other medicinal herbal plants.

In some non-limiting embodiments, susceptor element 975 may heat aerosolizable substance 980B and cover assembly 979 may vibrate to atomize aerosolizable substance 980A and the aerosol generated from aerosolizable substance 980A (e.g., a water-based aerosol generated from aerosolizable substance 980A) may mix with the aerosol generated from aerosolizable substance 980B. In this way, the aerosol generated from aerosolizable substance 980A may mix with the aerosol generated from aerosolizable substance 980B to provide a pleasurable experience for a user of vaporizer device 100. For example, an aerosol generated from aerosolizable substance 980A (e.g., an aerosol generated from aerosolizable substance 980A based on vibration) may serve to cool and flavor an aerosol generated from aerosolizable substance 980B (e.g., an aerosol generated from aerosolizable substance 980B based on heating). In some non-limiting embodiments, the opening of second reservoir 970B is adjacent to the opening of first reservoir 970A. In some non-limiting embodiments, the opening of second reservoir 970B is aligned with the opening of first reservoir 970A. For example, an axis drawn through a center of the opening of second reservoir 970B may be coaxial with an axis drawn through a center of the opening of first reservoir 970A. In some non-limiting embodiments, neck portion 970AA of first reservoir 970A may be positioned within a channel within an interior of vaporizer device 100 and second reservoir 970B may also be positioned within the channel. In this way, the aerosol generated from aerosolizable substance 980A may mix more completely with the aerosol generated from aerosolizable substance 980B than if first reservoir 970A and second reservoir 970B are not positioned with a same channel. In some non-limiting embodiments, frame 954 may support first reservoir 970A and second reservoir 970B so that first reservoir 970A and second reservoir 970B are positioned within the channel within the interior of vaporizer device 100.

In this way, the source of heat together with the source of vibration are used but the same source of energy, an alternating current electromagnetic field produced by an AC electric current through induction heating elements of induction heating element assembly 962, is used to control both the heat and the vibration. In this way, a more compact and simpler (e.g., less components) vaporizer device may be produced. In some non-limiting embodiments, frequencies (e.g., one or more frequencies of an alternating electrical current provided to induction heating element 762) used for causing vibration of cover assembly 979 and generating heat via induction based on induction heating elements of induction heating element assembly 962 may be in the range of 50 kHz to 300 kHz. For example, frequencies in the range of 100 kHz to 200 kHz may be used.

As shown in FIG. 9B, implementation 900B includes control device 112, power source 114, mouthpiece component 110, stopper 140, first housing portion 150, second housing portion 160, support 952, frame 954, induction heating element assembly 962, first reservoir 970A, second reservoir 970B, transducer element 972, susceptor element 975, cover assembly 979, and seal 988. In some non-limiting embodiments, support 952 may be the same as or similar to support 652, support 752, and/or support 852. In some non-limiting embodiments, frame 954 may be the same as or similar to frame 254, first frame 454, and/or second frame 456. In some non-limiting embodiments, induction heating element assembly 962 may be the same as or similar to induction heating element assembly 962. For example, the induction heating elements of induction heating element assembly 962 may be the same as or similar to induction heating element 462, induction heating element 762, and/or induction heating element 862. In some non-limiting embodiments, cover assembly 979 may be the same as or similar to cover assembly 679, cover assembly 779, and/or cover assembly 879. In some non-limiting embodiments, seal 988 may be the same as or similar to seal 688, seal 788, and/or seal 888. As further shown in FIG. 98, first reservoir 970A may contain aerosolizable substance 980A and second reservoir 970B may contain aerosolizable substance 980B. In some non-limiting embodiments, aerosolizable substance 980A and aerosolizable substance 980B may be the same as or similar to aerosolizable substance 280, aerosolizable substance 480, and/or aerosolizable substance 680, aerosolizable substance 780, aerosolizable substance 880A, and/or aerosolizable substance 880B.

In some non-limiting embodiments, induction heating element assembly 962C may include a plurality of induction heating elements positioned along a length of second reservoir 970B. In some non-limiting embodiments, one or more of induction heating elements of induction heating element assembly 9620 may be positioned around (e.g., surround, partially surround, etc.) second reservoir 970B. For example, all of induction heating elements may be positioned around the length of second reservoir 970B.

In some non-limiting embodiments, control device 112 may provide power from power source 114 to control one or more induction heating elements of induction heating element assembly 962C to generate an alternating current electromagnetic field. For example, control device 112 may provide power from power source 114 to cause one or more induction heating elements to generate an alternating current electromagnetic field. In some non-limiting embodiments, control device 112 may provide power from power source 114 to cause one or more induction heating elements to generate an alternating current electromagnetic field separately from other induction heating elements. For example, control device 112 may provide power from power source 114 to activate one or more induction heating elements of induction heating element assembly 962C separately from other induction heating elements to cause one or more induction heating elements to generate an alternating current electromagnetic field. In this way, a user may control vaporizer device 100 (e.g., control vaporizer device 100 via control device 112) to produce an aerosol from different sections of second reservoir 970B.

In some non-limiting embodiments, first reservoir 970A may contain aerosolizable substance 980A and cover assembly 979 may be used to aerosolize aerosolizable substance 980A. For example, cover assembly 979 may be positioned over an opening of reservoir 970A and cover assembly 979 may generate an aerosol from aerosolizable substance 980A when cover assembly 979 is vibrated. In some non-limiting embodiments, control device 112 may provide power from power source 114 to control transducer element 972 to cause cover assembly 979 to vibrate. In some non-limiting embodiments, cover assembly 979 may be supported in a manner that permits cover assembly 979 to vibrate. For example, cover assembly 979 may be supported by seal 988.

In some non-limiting embodiments, transducer element 972 may be configured to vibrate cover assembly 979. For example, control device 112 may provide power from power source 114 to control transducer element 972 to vibrate cover assembly 979 (e.g., to cause cover assembly 979 to vibrate). Additionally or alternatively, transducer element 972 may be attached to support 952 and/or transducer element 972 may be attached to cover assembly 979. In some non-limiting embodiments, implementation 900B may not include transducer element 972. For example, cover assembly 979 may vibrate based on an alternating electromagnetic field received by cover assembly 979 from induction heating element assembly 962C. In some non-limiting embodiments, control device 112 may provide power from power source 114 to control induction heating element assembly 962C (e.g., one or more induction heating elements of induction heating element assembly 962C) to cause induction heating element assembly 962C to generate an alternating electromagnetic field. The alternating electromagnetic field may be received by cover assembly 979 and the alternating electromagnetic field may cause cover assembly 979 to vibrate.

In some non-limiting embodiments, cover assembly 979 may be coupled to first reservoir 970A. For example, cover assembly 979 may be coupled to first reservoir 970A via seal 988. For example, seal 988 may be adjacent the opening of first reservoir 970A. Additionally or alternatively, seal 988 may be positioned between a rim of the opening of first reservoir 970A and cover assembly 979. In some non-limiting embodiments, seal 988 is positioned between an opening of first reservoir 970A (e.g., between a rim of first reservoir 970A that defines the opening of first reservoir 970A) and cover assembly 979. In some non-limiting embodiments, seal 988 may have a shape that corresponds to the opening of first reservoir 970A. For example, seal 988 may have an annular shape that corresponds to an annular shape of the opening of first reservoir 970A. In some non-limiting embodiments, an edge of a first surface of cover assembly 979 may be attached to a first surface of transducer element 972 and a second surface of transducer element 972 may be attached rigidly to support 952. Additionally or alternatively, an edge of a second surface of cover assembly 979 may be attached to seal 988. In this way, cover assembly 979 may interface with aerosolizable substance 980A in sub-reservoir 981A so that cover assembly 979 is allowed to vibrate but aerosolizable substance 980A is prevented from leaking out from sub-reservoir 981A.

In some non-limiting embodiments, cover assembly 979 may be used to aerosolize aerosolizable substance 980A. For example, cover assembly 879 may be positioned over an opening of first reservoir 970A and aerosolizable substance 980A may exit first reservoir 970A via the opening. Transducer element 972 may cause cover assembly 979 to vibrate, which may atomize aerosolizable substance 980A. In some non-limiting embodiments, control device 112 may provide power from power source 114 to control transducer element 972 to cause cover assembly 979 to vibrate.

In some non-limiting embodiments, susceptor element 975 may heat aerosolizable substance 980B and cover assembly 979 may vibrate to atomize aerosolizable substance 980A and the aerosol generated from aerosolizable substance 980A (e.g., a water-based aerosol generated from aerosolizable substance 980A) may mix with the aerosol generated from aerosolizable substance 980B. In this way, the aerosol generated from aerosolizable substance 980A may mix with the aerosol generated from aerosolizable substance 9808 to provide a pleasurable experience for a user of vaporizer device 100. For example, an aerosol generated from aerosolizable substance 980A (e.g., an aerosol generated from aerosolizable substance 980A based on vibration) may serve to cool and flavor an aerosol generated from aerosolizable substance 980B (e.g., an aerosol generated from aerosolizable substance 980B based on heating). In some non-limiting embodiments, the opening of second reservoir 970B is adjacent to the opening of first reservoir 970A. In some non-limiting embodiments, the opening of second reservoir 970B is spaced apart from the opening of first reservoir 970A. For example, second reservoir 970B may be supported by frame 954 and first reservoir 970A (e.g., sub-reservoir 981A of first reservoir 970A) may be supported by frame 954 such that the opening of second reservoir 970B is spaced apart from the opening of first reservoir 970A adjacent an air pathway defined in mouthpiece component 110.

In this way, the source of heat together with the source of vibration are used but the same source of energy, an alternating current electromagnetic field produced by an AC electric current through induction heating elements of induction heating element assembly 962C is used to control both the heat and the vibration. In this way, a more compact and simpler (e.g., simpler based on less components) vaporizer device may be produced. In some non-limiting embodiments, frequencies (e.g., one or more frequencies of an alternating electrical current provided to one or more induction heating elements of induction heating element assembly 962C) used for causing vibration of cover assembly 979 and generating heat via induction based on induction heating elements of induction heating element assembly 962C may be in the range of 50 kHz to 300 kHz. For example, frequencies in the range of 100 kHz to 200 kHz may be used.

In FIGS. 2, and 4-9B, electrical components (e.g., control device 112 and power source 114) are shown as being contained in first housing portion 150 for illustration purposes only. In some non-limiting embodiments, second housing portion 160 may contain one or more electrical components.

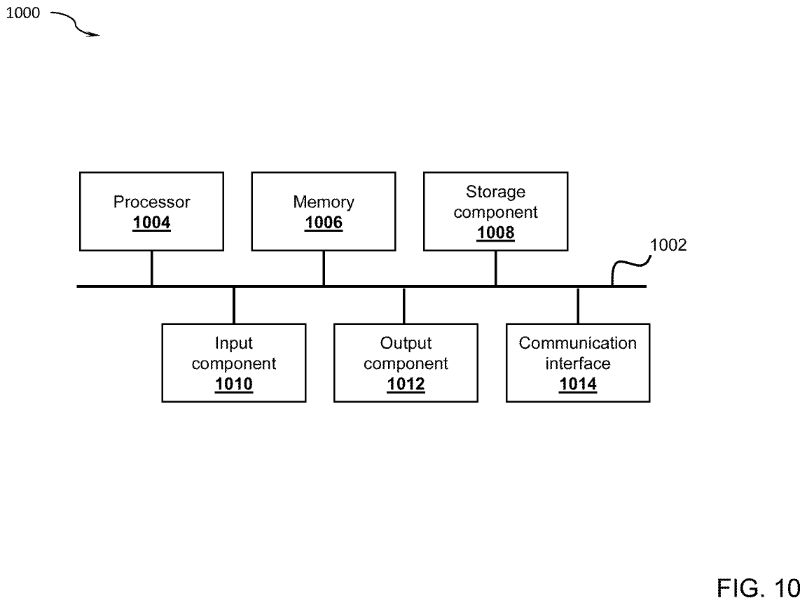

Referring now to FIG. 10, FIG. 10 is a diagram of example components of a device 1000. In some non-limiting embodiments, device 1000 may correspond to control device 112. In some non-limiting embodiments, control device 112 includes at least one device 1000 and/or at least one component of device 1000. As shown in FIG. 10, device 1000 includes bus 1002, processor 1004, memory 1006, storage component 1008, input component 1010, output component 1012, and communication interface 1014.

Bus 1002 includes a component that permits communication among the components of device 1000. In some non-limiting embodiments, processor 1004 is implemented in hardware, software (e.g., firmware), or a combination of hardware and software. For example, processor 1004 includes a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 1006 includes random access memory (RAM), read only memory (ROM), and/or another type of dynamic or static storage device (e.g., flash memory, magnetic memory, optical memory, etc.) that stores information and/or instructions for use by processor 1004.

In some non-limiting embodiments, storage component 1008 stores information and/or software related to the operation and use of device 1000. For example, storage component 1008 includes a hard disk (e.g., a magnetic disk, an optical disk, a magneto-optic disk, a solid state disk, etc.), a compact disc (CD), a digital versatile disc (DVD), a floppy disk, a cartridge, a magnetic tape, a flash memory device (e.g., a flash drive), and/or another type of computer-readable medium, along with a corresponding drive.

In some non-limiting embodiments, input component 1010 includes a component that permits device 1000 to receive information, such as via user input (e.g., a touch screen display, a keyboard, a keypad, a mouse, a button, a switch, a microphone, etc.). Additionally or alternatively, input component 1010 includes a sensor for sensing information (e.g., a temperature sensor, an accelerometer, a gyroscope, an actuator, a pressure sensor, etc.). Output component 1012 includes a component that provides output information from device 1000 (e.g., a display, a speaker, one or more light-emitting diodes (LEDs), etc.).

In some non-limiting embodiments, communication interface 1014 includes a transceiver-like component (e.g., a transceiver, a separate receiver and transmitter, etc.) that enables device 1000 to communicate with other devices, such as via a wired connection, a wireless connection, or a combination of wired and wireless connections. In some non-limiting embodiments, communication interface 1014 permits device 1000 to receive information from another device and/or provide information to another device. For example, communication interface 1014 includes an Ethernet interface, an optical interface, a coaxial interface, an infrared interface, a radio frequency (RF) interface, a universal serial bus (USB) interface, a Wi-Fi® interface, a cellular network interface, a Bluetooth® interface, and/or the like.

In some non-limiting embodiments, device 1000 performs one or more processes described herein. In some non-limiting embodiments, device 1000 performs these processes based on processor 1004 executing software instructions stored by a computer-readable medium, such as memory 1006 and/or storage component 1008. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions are read into memory 1006 and/or storage component 1008 from another computer-readable medium or from another device via communication interface 1014. In some non-limiting embodiments, when executed, software instructions stored in memory 1006 and/or storage component 1008 cause processor 1004 to perform one or more processes described herein. Additionally or alternatively, hardwired circuitry is used in place of or in combination with software instructions to perform one or more processes described herein. Thus, embodiments described herein are not limited to any specific combination of hardware circuitry and software.

The number and arrangement of components shown in FIG. 10 are provided as an example. In some non-limiting embodiments, device 1000 includes additional components, fewer components, different components, or differently arranged components than those shown in FIG. 10. Additionally or alternatively, a set of components (e.g., one or more components) of device 1000 may perform one or more functions described as being performed by another set of components of device 1000.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular form of “a,” “an,” and “the” include plural referents unless the context clearly dictates otherwise.

What is claimed is:

1. A device for aerosolization of an aerosolizable substance comprising:
a resistive heating element;
a wick element; and
a transducer element; and
wherein the resistive heating element is configured to heat the wick element via conduction; and
wherein the resistive heating element is attached to the transducer element; and
wherein the transducer element is configured to cause the heating element to vibrate.

2. The device of claim 1, further comprising:
at least one processor programmed or configured to:
control the transducer element to cause the resistive heating element to vibrate.

3. The device of claim 1, further comprising:
a support, wherein the transducer element is attached to the support.

4. The device of claim 3, further comprising:
a housing;
a frame located within the housing; and
wherein the support is attached to the frame;
wherein the support is configured to hold the transducer element and the resistive heating element in a predetermined position within the housing to allow the heating element to heat the wick element.

5. The device of claim 1, wherein the resistive heating element comprises a resistive heating coil.

6. The device of claim 5, wherein the resistive heating element is in contact with the wick element and wherein the wick element is positioned within the resistive heating element.

7. A device for aerosolization of an aerosolizable substance comprising:
a resistive heating element;
a wick element; and
a magnetic element; and
wherein the resistive heating element configured to heat the wick element via conduction; and
wherein the magnetic element is configured to cause the resistive heating element to vibrate.

8. The device of claim 7, wherein the magnetic element comprises a ferromagnetic material.

9. A device for aerosolization of an aerosolizable substance comprising:
a induction heating element; and
a susceptor element; and
wherein the induction heating element is configured to cause the susceptor element to generate heat based on induction; and
wherein the induction heating element is configured to cause the susceptor element to vibrate based on an alternating current magnetic field generated by the induction heating element.

10. The device of claim 9, further comprising:
at least one processor programmed or configured to:
control the induction heating element to cause the susceptor element to vibrate.

11. The device of claim 9, wherein the susceptor element is coupled to a membrane diaphragm, wherein the membrane diaphragm is configured to allow the susceptor element to vibrate when the susceptor element receives the alternating current magnetic field generated by the induction heating element.

12. The device of claim 11, wherein the membrane diaphragm is attached to an opening of a reservoir, and wherein the membrane diaphragm is configured to hold a first portion of the susceptor element within the induction heating element and a second portion of the susceptor element within the reservoir.

13. The device of claim 9, wherein the susceptor element comprises a central portion and a plurality of conductive filaments attached to the central portion.

14. The device of claim 11, wherein the membrane diaphragm comprises a first portion and a second portion attached to the first portion, wherein the first portion is coupled to the susceptor element and wherein the second portion is attached to an opening of a reservoir.

15. The device of claim 9, wherein the susceptor element comprises a central portion having a conical shape, wherein the central portion is constructed from a foil perforated with a plurality of apertures.

16. The device of claim 15, wherein a membrane diaphragm is attached to an opening of a reservoir, and wherein the membrane diaphragm is configured to hold at least a portion of the susceptor element within the induction heating element.

17. A device for aerosolization of an aerosolizable substance comprising:
a resistive heating element;
a reservoir configured to contain an aerosolizable substance, the reservoir comprising an opening;
a cover assembly positioned over the opening of the reservoir;
a transducer element configured to vibrate the cover assembly; and
wherein the resistive heating element is configured to heat the aerosolizable substance via induction; and
wherein the resistive heating element is positioned adjacent the opening of the reservoir.

18. The device of claim 17, further comprising:
at least one processor programmed or configured to:
control the resistive heating element to cause the resistive heating element to heat the aerosolizable substance via conduction, and
control the transducer element to cause the transducer element to vibrate.

19. The device of claim 17, further comprising:
a support, wherein the transducer element is attached to the support.

20. The device of claim 17, wherein the cover assembly is attached to the transducer element.

21. The device of claim 17, wherein the cover assembly is constructed from a foil perforated with a plurality of apertures.

22. The device of claim 17, further comprising:
a seal adjacent the opening of the reservoir, wherein the seal is positioned between a rim of the reservoir and the cover assembly.

23. A device for aerosolization of an aerosolizable substance comprising:
a induction heating element;
a susceptor element;
a reservoir configured to contain an aerosolizable substance, the reservoir comprising an opening;
a cover assembly positioned over the opening of the reservoir; and
wherein the induction heating element is configured to cause the susceptor element to generate heat based on induction; and
wherein the induction heating element is positioned adjacent the opening of the reservoir.

24. The device of claim 23, further comprising:
at least one processor programmed or configured to:
control the induction heating element to cause the susceptor element to generate heat based on induction.

25. The device of claim 23, wherein the cover assembly is constructed from a foil perforated with a plurality of apertures.

26. The device of claim 23, wherein the induction heating element is configured to cause the cover assembly to vibrate based on an alternating current magnetic field generated by the induction heating element.

27. The device of claim 23, further comprising:
a seal adjacent the opening of the reservoir, wherein the seal is positioned between a rim of the reservoir and the cover assembly.

28. The device of claim 23, further comprising:
a magnetic element, wherein the magnetic element is attached to the cover assembly and is configured to cause the cover assembly to vibrate based on an alternating current magnetic field generated by the induction heating element.

29. The device of claim 23, further comprising:
a transducer element, wherein the transducer element is attached to the cover assembly and is configured to vibrate the cover assembly.

30. The device of claim 23, wherein the susceptor element is a first susceptor element, wherein the reservoir is a first reservoir configured to contain a first aerosolizable substance, and the device further comprising:
a second reservoir configured to contain a second aerosolizable substance, wherein the first aerosolizable substance is different than the second aerosolizable substance;
a second susceptor element;
wherein the first susceptor element is positioned within an opening of the second reservoir; and
wherein the second susceptor element is positioned within an opening of the second reservoir.

31. The device of claim 23, wherein the reservoir is a first reservoir configured to contain a first aerosolizable substance, further comprising:
a second reservoir comprising an opening, wherein the second reservoir is configured to contain a second aerosolizable substance, wherein the susceptor element is positioned within the second reservoir, and wherein the second reservoir is positioned within the induction heating element;
wherein the opening of the second reservoir is adjacent to the opening of the first reservoir.

32. The device of claim 31, wherein the opening of the second reservoir is aligned with the opening of the first reservoir.
